(19) United States
(12) Patent Application Publication
(10) Pub. No.: US 2018/0203540 A1
(43) Pub. Date: Jul. 19, 2018

(54) DISCRIMINATIVE CONTROLLER AND DRIVING METHOD FOR TOUCH PANEL WITH ARRAY ELECTRODES

(71) Applicant: Sharp Kabushiki Kaisha, Osaka (JP)

(72) Inventors: Sean Thomas George MAGUIRE, Oxford (GB); Diego GALLARDO, Oxford (GB)

(21) Appl. No.: 15/409,910

(22) Filed: Jan. 19, 2017

(51) Int. Cl. G06F 3/044; G06F 3/041

(52) U.S. Cl. CPC G06F 3/044; G06F 2203/04108; G06F 3/0416

(57) ABSTRACT

A touch panel device includes a two dimensional array of electrodes comprising a plurality of electrodes, and a controller electrically coupled to the two dimensional array of electrodes. A first portion of the electrodes are assignable by the controller as drive electrodes or unused electrodes, and a second portion of the electrodes are assignable by the controller as sense electrodes or unused electrodes. The controller is configured to: assign drive electrodes and sense electrodes during a plurality of measurement periods, wherein a pattern of assigned drive electrodes and sense electrodes is different during different measurement periods, and form mutual capacitances over a plurality of coupling distances during the plurality of measurement periods; measure mutual capacitances formed between the drive electrodes and the sense electrodes during the measurement periods; and detect and determine a position of an object that is touching or in close proximity to the touch panel device based on the measured mutual capacitances.

### TECHNICAL FIELD

The present invention relates to touch panel devices. In particular, this invention relates to capacitive type touch panels. Such a capacitive type touch panel device may find application in a range of consumer electronic products including, for example, mobile phones, tablet and desktop PCs, electronic book readers and digital signage products.

### BACKGROUND ART

Touch panels have become widely adopted as the input device for a range of electronic products such as smart-phones and tablet devices.

Most high-end portable and handheld electronic devices now include touch panels. These are most often used as part of a touchscreen, i.e., a display and a touch panel that are aligned so that the touch zones of the touch panel correspond with display zones of the display.

The most common user interface for electronic devices with touchscreens is an image on the display, the image having points that appear interactive. More particularly, the device may display a picture of a button, and the user can then interact with the device by touching, pressing or swiping the button with their finger or with a stylus. For example, the user can “press” the button and the touch panel detects the touch (or touches). In response to the detected touch or touches, the electronic device carries out some appropriate function. For example, the electronic device might turn itself off, execute an application, or the like.

Although a number of different technologies can be used to create touch panels, capacitive systems have proven to be the most popular due to their accuracy, durability and ability to detect touch input events with little or no activation force.

A well-known approach to capacitive sensing applied to touch panels is the projected capacitive approach. This approach includes the mutual-capacitance method and the self-capacitance method.

In the mutual-capacitance method, as shown in FIG. 1, a drive electrode 100 and sense electrode 101 are formed on a transparent substrate (not shown). A changing voltage or excitation signal is applied to the drive electrode 100 from a voltage source 102. A signal is then generated on the adjacent sense electrode 101 by means of capacitive coupling via the mutual coupling capacitor 103 formed between the drive electrode 100 and sense electrode 101. A current measurement unit or means 104 is connected to the sense electrode 101 and provides a measurement of the size of the mutual coupling capacitor 103. When the input object 105 (such as a figure or stylus) is brought into close proximity to both electrodes, it forms a first dynamic capacitor to the drive electrode 106 and a second dynamic capacitor to the sense electrode 107. If the input object is connected to ground, as is the case for example for a human finger connected to a human body, the effect of these dynamically formed capacitances is manifested as a reduction of the amount of capacitive coupling in between the drive and sense electrodes and hence a reduction in the magnitude of the signal measured by the current measurement unit or means 104 attached to the sense electrode 101.

In the self-capacitance method, as shown in FIG. 2, a drive electrode 200 is formed on a transparent substrate (not shown). A changing voltage or excitation signal is applied to the drive electrode 200 from a voltage source 201. A current measurement means 202 is connected to the electrode 200 and provides a measurement of the size of the self-capacitance 203 of the electrode to ground. When the input object 105 is brought into close proximity to the electrode, it changes the value of the self-capacitance 203. If the input object is connected to ground, as is the case for example of a human finger connected to a human body, the effect is to increase the self-capacitance of the electrode to ground 203 and hence to increase the magnitude of the signal measured by the current measurement means 202 attached to the sense electrode 200.

As is well-known and disclosed, for example, in U.S. Pat. No. 5,841,078 (Bisset et al, issued Oct. 30, 1996), by arranging a plurality of drive and sense electrodes in a grid pattern to form an electrode array, the mutual-capacitance sensing method may be used to form a touch panel device. FIG. 3 shows a suitable pattern of horizontal electrodes 300 that may be configured as drive electrodes, and vertical electrodes 301 that may be configured as sense electrodes. An advantage of the mutual-capacitance sensing method is that multiple simultaneous touch input events may be detected.

It is well-known that by arranging a plurality of electrodes in a grid pattern to form an electrode array, the self-capacitance sensing method may be used to form a touch panel device. FIG. 3 shows a suitable pattern of horizontal electrodes 300 and vertical electrodes 301 that may be configured as sense electrodes. However, a limitation of such a device is that it cannot reliably detect simultaneous touches from multiple objects.

It is also well-known and disclosed, for example, in U.S. Pat. No. 9,250,735 (Kim et al, issued Feb. 2, 2016), that by arranging a plurality of electrodes in a two dimensional array, and by providing an electrical connection from each electrode to a controller, this self-capacitance sensing method may be used to form a touch panel device that is able to reliably detect simultaneous touches from multiple objects. Mutual capacitance sensing may also be used with such a two dimensional array of separately-connected electrodes, for example as disclosed in US 2016/0320886 (Kim et al, published Nov. 3, 2016).

In many touch screens the touch panel is a device independent of the display, known as an “out-cell” touch panel. The touch panel is positioned on top of the display, and the light generated by the display crosses the touch panel, with an amount of light being absorbed by the touch panel. In more recent implementations, part of the touch panel is integrated within the display stack, and touch panel and display may share the use of certain structures, such as transparent electrodes. This is known as an “in-cell” touch panel. This integration of the touch panel into the display structure seeks to reduce cost by simplifying manufacture, as well as reducing the loss of light throughput that occurs when the touch panel is independent of the display and located on top of the display stack.

A limitation of the capacitance measurement techniques described above as conventionally applied to touch panels is that they are incapable of detecting input from non-conductive or insulating objects, for example made of wood, plastic or the like. A non-conductive object that has a dielectric permittivity different to air will cause the measured array capacitances to change when in close proximity to the touch panel surface. However, the magnitude of the resulting signal is very small—for example, less than 1% of that generated by a conductive object—and is dependent on the type of material the non-conductive object is made of and the ambient environment conditions. This disadvantageously reduces the usability of the touch panel since it is restricted to operation using conductive input objects, such as a finger or metallic pen or stylus. In particular, the user cannot operate a touch panel reliably while wearing normal (non-conductive) gloves or while holding a non-conductive object such as a plastic pen.

U.S. Pat. No. 9,105,255 (Brown et al, issued Aug. 11, 2015) discloses a type of mutual-capacitance touch panel that is able to detect non-conductive objects, and to distinguish whether an object is conductive or non-conductive. This is achieved by measuring multiple mutual capacitances formed over different coupling distances. The type of object (conductive or non-conductive) can be determined based on the changes in the multiple mutual capacitances. The multiple mutual capacitances are formed between an array of row and column electrodes.

A limitation of the prior art is that no method is disclosed for detecting non-conductive objects, or for distinguishing between conductive and non-conductive objects, using a two dimensional array of electrodes which each have a separate connection to a controller. This may be desirable because it may be cheaper and/or technically simpler to implement a two dimensional array of separately-connected electrodes, rather than an array of row and column electrodes, in certain applications. In addition, it may reduce or eliminate the need for connections in the bezel area of the panel.

### SUMMARY OF THE INVENTION

The present invention relates to a controller and method of driving a capacitive touch panel, wherein the touch panel comprises a two dimensional array of electrodes and each of the electrodes in the array, or alternatively each of the sense electrodes only, has a separate electrical connection to the controller. The present invention can use any such two dimensional array of electrodes, and does not depend on any particular touch panel structure or fabrication technique. The present invention is thereby capable of detecting both conductive and non-conductive objects that are touching or in close proximity to the touch panel.

The controller measures the mutual capacitance between groups of electrodes during multiple measurement periods. In each measurement period, the controller assigns some electrodes as drive electrodes, some electrodes as sense electrodes, and some electrodes as unused electrodes. The controller applies a drive signal to the drive electrodes, and measures the coupling between the drive electrodes and each sense electrode. The unused electrodes may be connected to ground, or connected to a fixed voltage, or left unconnected.

The assignment of drive and sense electrodes during a measurement period creates coupling over different distances between different groups of drive and sense electrodes. For example, coupling between certain drive and sense electrodes may be over a short distance, and coupling between other drive and sense electrodes may be over a long distance.

In each measurement period, it is possible to use a different assignment of drive and sense electrodes. By using multiple different electrode assignments, the controller can determine the coupling, for each coupling distance, corresponding to multiple positions on the surface of the touch panel. The electrode assignments are chosen such that these positions cover the whole of or a significant part of the touch panel surface.

The data generated by the controller represents measurements of multiple mutual capacitances over different coupling distances, corresponding to different points on the surface of the touch panel. These measurements can be used to detect one or more objects that are touching the touch panel, or are in close proximity to the touch panel, and to determine the position of those objects on the surface of the touch panel. These objects may be conductive or non-conductive. The measurements can also be used to determine whether each object is conductive or non-conductive. The measurements can further be used to determine the height of each object above the touch panel.

### BRIEF DESCRIPTION OF DRAWINGS

FIG. 1 shows a typical implementation of a mutual-capacitance touch panel.

FIG. 2 shows a typical implementation of a self-capacitance touch panel.

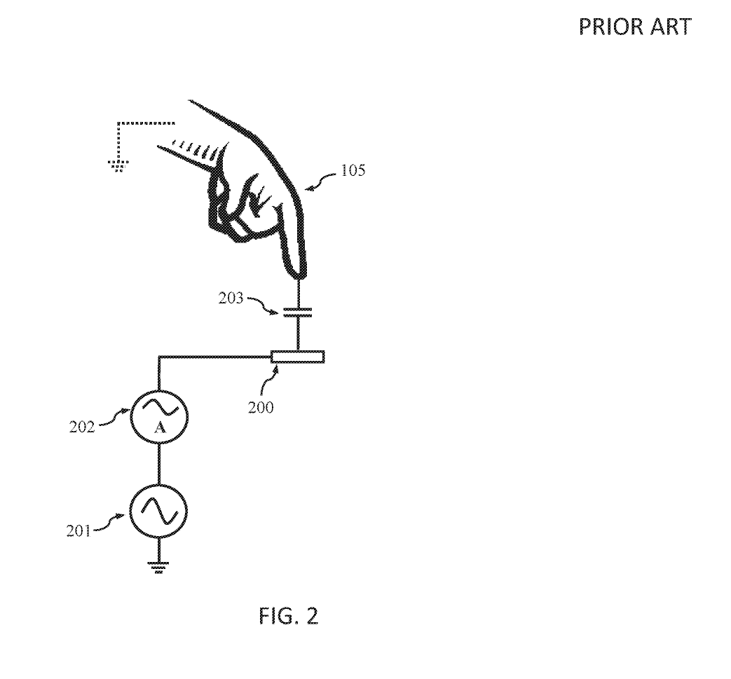

FIG. 3 shows a typical pattern of vertical and horizontal electrodes that may be used for mutual- or self-capacitance sensing.

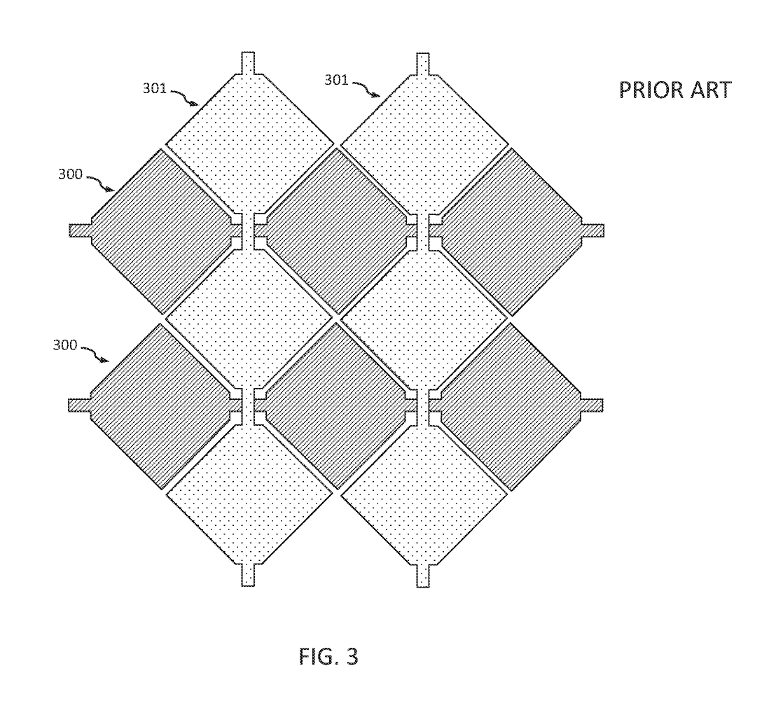

FIG. 4 shows a touch panel display system.

FIG. 5 shows a two-dimensional array of electrodes on a first layer, with connections on a second layer to a controller.

FIG. 6 shows a two-dimensional array of electrodes on a first layer, with connections on the first layer to a controller.

FIG. 7 shows a multiplexer unit that may be used with the electrode arrays of FIG. 5 and FIG. 6.

FIG. 8 shows a charge amplifier circuit suitable for measuring a mutual capacitance.

FIG. 9 shows waveforms that may be used to drive the amplifier of FIG. 8

FIG. 10 shows a simplified representation of a two dimensional electrode array.

FIG. 11 shows an electrode assignment that may be used during a first measurement period.

FIG. 12 shows an electrode assignment that may be used during a second measurement period.

FIG. 13 shows an electrode assignment that may be used during a third measurement period.

FIG. 14 shows the electrode pattern of FIG. 11 and the approximate sensitive regions corresponding to mutual capacitances formed over short coupling distances.

FIG. 15 shows the electrode pattern of FIG. 12 and the approximate sensitive regions corresponding to mutual capacitances formed over short coupling distances.

FIG. 16 shows the electrode pattern of FIG. 13 and the approximate sensitive regions corresponding to mutual capacitances formed over short coupling distances.

FIG. 17 shows the approximate sensitive regions corresponding to mutual capacitances formed over short coupling distances during a series of five measurement periods.

FIG. 18 shows the electrode pattern of FIG. 11 and the approximate sensitive regions corresponding to mutual capacitances formed over long coupling distances.

FIG. 19 shows the electrode pattern of FIG. 12 and the approximate sensitive regions corresponding to mutual capacitances formed over long coupling distances.

FIG. 20 shows the electrode pattern of FIG. 13 and the approximate sensitive regions corresponding to mutual capacitances formed over long coupling distances.

FIG. 21 shows an electrode assignment that may be used to improve spatial resolution at the panel edge.

FIG. 22 shows the electrode pattern of FIG. 21 and the approximate sensitive regions corresponding to mutual capacitances formed over short coupling distances.

FIG. 23 shows an electrode assignment that may be used to improve spatial resolution at the panel edge and the approximate sensitive regions corresponding to mutual capacitances formed over short coupling distances.

FIG. 24 shows an asymmetrical electrode assignment that may be used during a first measurement period.

FIG. 25 shows an asymmetrical electrode assignment that may be used during a second measurement period.

FIG. 26 shows a two-dimensional array of electrodes on a first layer, with connections on a second layer to a controller, where the electrodes are interdigitated in one direction.

FIG. 27 shows the electrode assignment of FIG. 11 applied to the touch sensor panel embodiment of FIG. 26.

FIG. 28 shows the electrode assignment of FIG. 12 applied to the touch sensor panel embodiment of FIG. 26.

FIG. 29 shows an embodiment of a touch sensor panel which uses an array of electrodes with a diamond geometry.

FIG. 30 shows a multiplexer unit that may be used with the electrode array of FIG. 29.

FIG. 31 shows an embodiment of a touch sensor panel which uses an array of electrodes with a diamond geometry and with common connections to groups of drive electrodes.

FIG. 32 shows a multiplexer unit that may be used with the electrode array of FIG. 31.

FIG. 33 shows an embodiment of a routing unit that is able to change the connections between the connecting lines and the multiplexers in the embodiment of FIG. 30.

FIG. 34 shows an electrode assignment that may be used with the electrode structure of FIG. 29 or FIG. 31 during a first measurement period.

FIG. 35 shows an electrode assignment that may be used with the electrode structure of FIG. 29 or FIG. 31 during a second measurement period.

FIG. 36 shows the electrode pattern of FIG. 34 and the approximate sensitive regions corresponding to mutual capacitances formed over short coupling distances.

FIG. 37 shows the electrode pattern of FIG. 35 and the approximate sensitive regions corresponding to mutual capacitances formed over short coupling distances.

FIG. 38 shows the electrode pattern of FIG. 34 and the approximate sensitive regions corresponding to mutual capacitances formed over long coupling distances.

FIG. 39 shows the electrode pattern of FIG. 35 and the approximate sensitive regions corresponding to mutual capacitances formed over long coupling distances.

FIG. 40 shows a flow diagram depicting the steps that may be performed within the touch panel controller to measure and process capacitance data from the touch sensor panel.

FIG. 41 shows the sub-steps that form part of the first step shown in FIG. 40.

FIG. 42 shows the sub-steps that form part of the second step shown in FIG. 40.

FIG. 43 shows the sub-steps that form part of the third step shown in FIG. 40.

FIG. 44 shows an electrode assignment that may be used during a measurement period, and the approximate sensitive regions corresponding to mutual capacitances formed over short coupling distances.

FIG. 45 shows an electrode assignment that may be used during a measurement period, and the approximate sensitive regions corresponding to mutual capacitances formed over long coupling distances.

### DESCRIPTION OF REFERENCE NUMERALS

100 Drive electrode

101 Sense electrode

102 Voltage source

103 Mutual coupling capacitor

104 Current measurement means

105 Input object

106 Dynamic capacitor between input object and drive electrode

107 Dynamic capacitor between input object and sense electrode

200 Drive electrode

201 Voltage source

202 Current measurement means

203 Self-capacitance of electrode to ground

300 Horizontal electrodes

301 Vertical electrodes

400 Touch panel display system

401 Touch sensor panel

402 Display

403/403a/403b/403c Touch panel controller

404/404a/404b/404c Multiplexer unit

405 Measurement/processing unit

406 System control unit

500 Square electrodes

501 Vias

502 Connecting lines

504 Connecting lines for first column of electrodes

505 Connecting lines for second column of electrodes

506 Connecting lines for third column of electrodes

600 Square electrode

601 Conductive lines

700 Multiplexer

701 Multiplexer

702 Multiplexer

703 Multiplexer

704 Charge amplifier

705 Charge amplifier

706 Charge amplifier

707 Charge amplifier

708 Multiplexer

709 Multiplexer

710 Multiplexer

711 Multiplexer

712 Multiplexer

713 Multiplexer

714 Switch

715 Switch

716 Switch

717 Switch

718 Switch

719 Switch

720 Switch

721 Switch

722 Switch

723 Switch

724 Switch

725 Switch

800 Operational amplifier

801 Integration capacitor

802 Reset switch

803 First input switch

804 Second input switch

1000 Electrodes

1100 Sense electrodes

1101 Drive electrodes

1102 Unused electrodes

1200 Drive electrodes

1201 Sense electrodes

1202 Unused electrodes

1300 Unused electrodes

1301 Drive electrodes

1302 Sense electrodes

1400 Approximate region of mutual capacitance

1401 Approximate region of mutual capacitance

1500 Approximate region of mutual capacitance

1501 Approximate region of mutual capacitance

1600 Approximate region of mutual capacitance

1601 Approximate region of mutual capacitance

1700 Electrode array

1701 Approximate region of mutual capacitance

1702 Approximate region of mutual capacitance

1703 Approximate region of mutual capacitance

1704 Approximate region of mutual capacitance

1800 Approximate region of mutual capacitance

1801 Approximate region of mutual capacitance

1802 Approximate region of mutual capacitance

1900 Approximate region of mutual capacitance

1901 Approximate region of mutual capacitance

1902 Approximate region of mutual capacitance

1903 Approximate region of mutual capacitance

2000 Approximate region of mutual capacitance

2001 Approximate region of mutual capacitance

2002 Approximate region of mutual capacitance

2003 Approximate region of mutual capacitance

2100 Sense electrodes

2101 Drive electrodes

2102 Unused electrodes

2200 Approximate region of mutual capacitance

2201 Approximate region of mutual capacitance

2300 Drive electrodes

2301 Sense electrodes

2302 Unused electrodes

2303 Approximate region of mutual capacitance

2304 Approximate region of mutual capacitance

2400 Drive electrodes

2401 Sense electrodes

2402 Unused electrodes

2500 Unused electrodes

2501 Sense electrodes

2502 Drive electrodes

2600 Interdigitated electrodes

2601 Interdigitated electrodes

2602 Interdigitated electrodes

2603 Vias

2604 Connecting lines

2700 Sense electrodes

2701 Drive electrodes

2702 Unused electrodes

2800 Drive electrodes

2801 Sense electrodes

2802 Unused electrodes

2900 First electrodes

2900a/2900b First electrode parts

2901 Second electrodes

2901a/2901b second electrode parts

2902 Connecting features

2903 Vias

2904 Connecting line

2905 Connecting lines

2906 Connecting lines

2907 Connecting lines

2908 Connecting lines

2909 Connecting lines

2910 Connecting lines

2911 Connecting lines

2912 Connecting lines

2913 Connecting lines

3000 Routing unit

3100 First electrodes

3100a/3100b First electrode parts

3101 Second electrodes

3101a/3101b Second electrode parts

3102 Connecting features

3103 Vias

3104 Connecting line

3105 Connecting line

3106 Connecting line

3107 Connecting line

3108 Connecting line

3109 Connecting line

3110 Connecting line

3111 Connecting lines

3112 Connecting lines

3113 Connecting lines

3300 Switch array

3301 Control unit

3302 Control signals

3400 Sense electrodes

3401 Drive electrodes

3402 Unused electrodes

3500 Sense electrodes

3501 Drive electrodes

3502 Unused electrodes

3600 Approximate region of mutual capacitance

3601 Approximate region of mutual capacitance

3700 Approximate region of mutual capacitance

3701 Approximate region of mutual capacitance

3800 Approximate region of mutual capacitance

3801 Approximate region of mutual capacitance

3900 Approximate region of mutual capacitance

3901 Approximate region of mutual capacitance

4000 First algorithm step

4001 Second algorithm step

4002 Third algorithm step

4100 First sub-step of first algorithm step

4101 Second sub-step of first algorithm step

4102 Third sub-step of first algorithm step

4200 First sub-step of second algorithm step

4201 Second sub-step of second algorithm step

4202 Third sub-step of second algorithm step

4203 Fourth sub-step of second algorithm step

4300 First sub-step of third algorithm step

4301 Second sub-step of third algorithm step

4400 Unused electrodes

4401 Drive electrodes

4402 Sense electrodes

4403 Approximate region of mutual capacitance

4404 Approximate region of mutual capacitance

4405 Approximate region of mutual capacitance

4406 Approximate region of mutual capacitance

4500 Drive electrodes

4501 Unused electrodes

4502 Sense electrodes

4503 Approximate region of mutual capacitance

4504 Approximate region of mutual capacitance

4505 Approximate region of mutual capacitance

4506 Approximate region of mutual capacitance

### DETAILED DESCRIPTION OF INVENTION

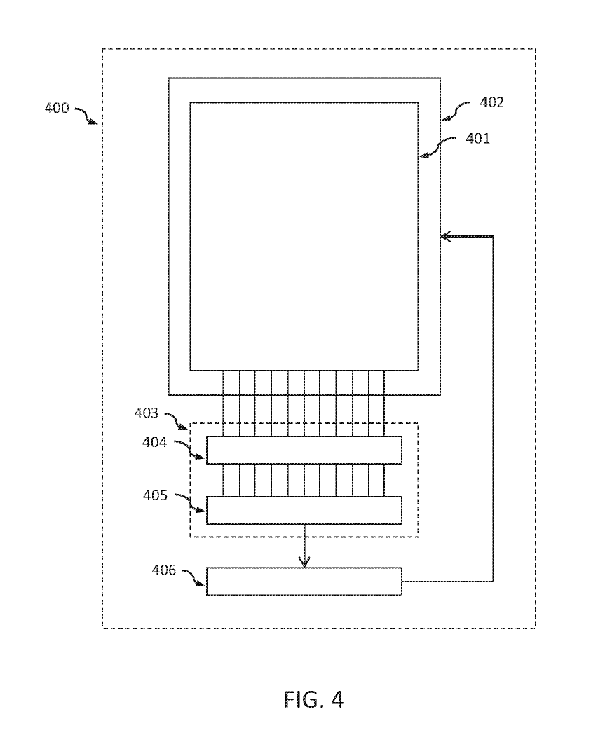

The present invention provides a controller and method of driving a capacitive touch panel that may be used, for example, in touch panel display systems or the like. FIG. 4 shows one embodiment of such a touch panel display system 400. This system includes a touch sensor panel 401, connected to a touch panel controller 403. The controller 403 may include a multiplexer unit 404 and a measurement/processing unit 405. In other embodiments, the multiplexer unit 404 may be separate from the controller 403. The controller detects touches on the touch sensor panel and determines the properties of the touches. This information is provided to a system control unit 406 that may include, for example, a processor, memory, and a display driver. The system control unit 406 outputs visual information to a display 402. The display may be, for example, an LCD or an OLED display or another type of display. The system control unit 406 may perform an action and may modify the visual information in response to touches detected by the controller 403.

The present invention can include any two dimensional electrode array where all of the electrodes have a separate electrical connection to a controller. The present invention can alternatively include any two dimensional electrode array comprising drive electrodes and sense electrodes, where all of the sense electrodes have a separate electrical connection to a controller.

Here “two dimensional array” means a number of electrodes arranged on or near a surface such that there is a first number of electrodes in a first direction, and a second number of electrodes in a second direction, and the total number of electrodes is greater than the sum of the first number and the second number. Note that the array may include electrodes that are separated from each other in three dimensions, for example if different electrodes are on different layers of the touch panel, or if the touch panel surface is curved. Not also that the electrodes may overlap each other.

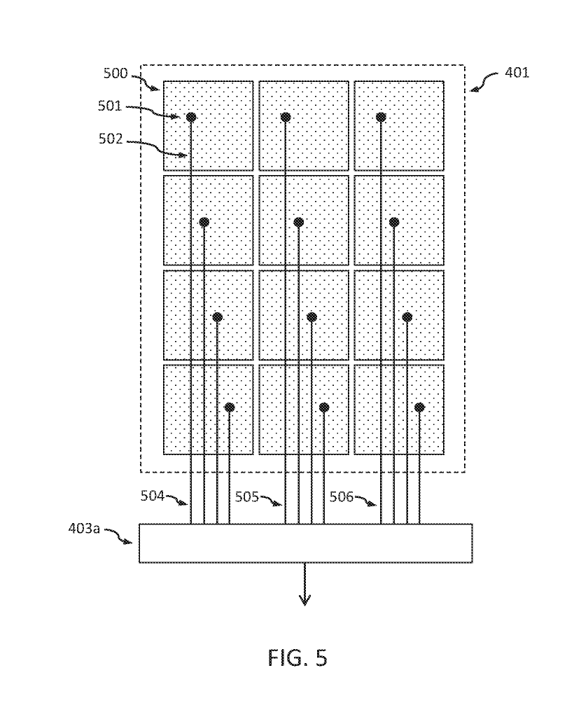

FIG. 5 shows one embodiment of a two dimensional electrode array forming a touch sensor panel 401. This array includes twelve square electrodes 500 formed on a first layer, with four electrodes arranged in a first direction and three electrodes arranged in a second direction. Vias 501 connect each electrode 500 on the first layer to connecting lines 502 on a second layer. By this means, each electrode 500 is separately connected to a controller 403a by connecting lines 502. The first column of electrodes is connected by connecting lines 504, the second column is connected by connecting lines 505, and the third column is connected by means of connecting lines 506.

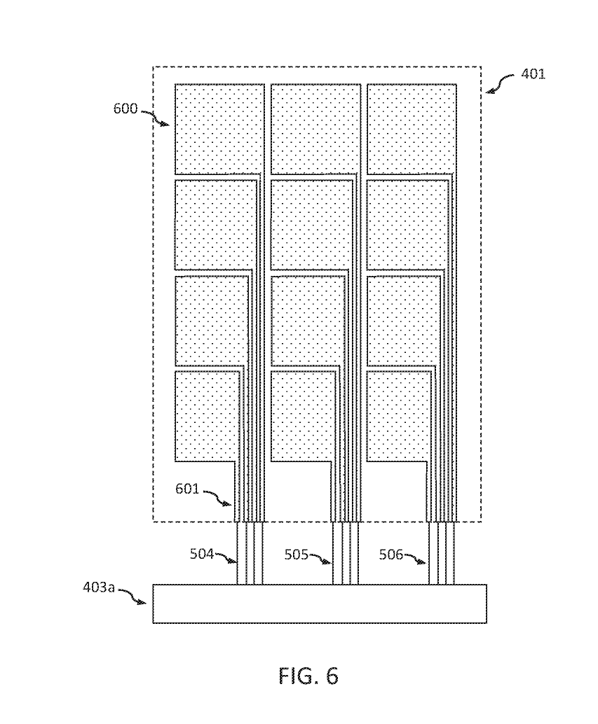

FIG. 6 shows another embodiment of a two dimensional electrode array forming a touch sensor panel 401. This array includes twelve square electrodes 600 formed on a first layer, with four electrodes arranged in a first direction and three electrodes arranged in a second direction. Each electrode 600 is separately connected to a controller 403a by means of conductive lines 601 on the first layer, and additional connecting lines 504, 505, and 506 similar to the previous embodiment.

It will be clear to those skilled in the art that there are many two dimensional electrode array structures that may be used. It will also be clear that many of these structures can be made as discrete “out-cell” touch panels, which may be bonded to a separate display, and that many of these structures can be integrated within a display device as an “in-cell” or “hybrid in-cell” touch panel. Furthermore, the electrode array structure may use one conductive layer or two conductive layers or more. Similarly, the electrodes may be disposed on one layer or on more than one layer.

For example, one way to form the electrodes 500 of FIG. 5 and the electrodes 600 of FIG. 6 is to deposit and pattern a transparent conductive layer, made of a material such as ITO, on a transparent substrate. This may be done using standard photolithographic or printing techniques.

The vias 501 and connecting lines 502 of FIG. 5 may also be formed using standard photolithographic or printing techniques. For example, an insulating layer may be deposited on top of the first conducting layer and patterned to produce holes for the vias, and a second conductive layer may be deposited on top of the insulating layer. This second conductive layer forms the vias 501, and may be patterned to form the connecting lines 502. These techniques are suitable for producing a discrete (“out-cell”) touch panel.

Alternatively, the touch panel may be integrated within a display device. For example, the electrodes 500 of FIG. 5 and the electrodes 600 of FIG. 6 may be formed by segmenting the VCOM layer of a liquid crystal display device. Similarly, the vias 501 and connecting lines 502 may be formed using the same layering processes that are used to fabricate the display data and/or gate lines.

Structures and techniques for fabricating suitable out-cell and in-cell touch panels are well-known in the prior art. The present invention can use any two dimensional array of separately-connected electrodes, and does not depend on any particular touch panel structure or fabrication technique.

The present invention assigns different electrodes to be drive electrodes and sense electrodes during different measurement periods. Some electrodes may be neither drive nor sense electrodes during a particular measurement period. These unused electrodes may be connected to ground or to a fixed voltage, for example, in some embodiments, or left unconnected in other embodiments.

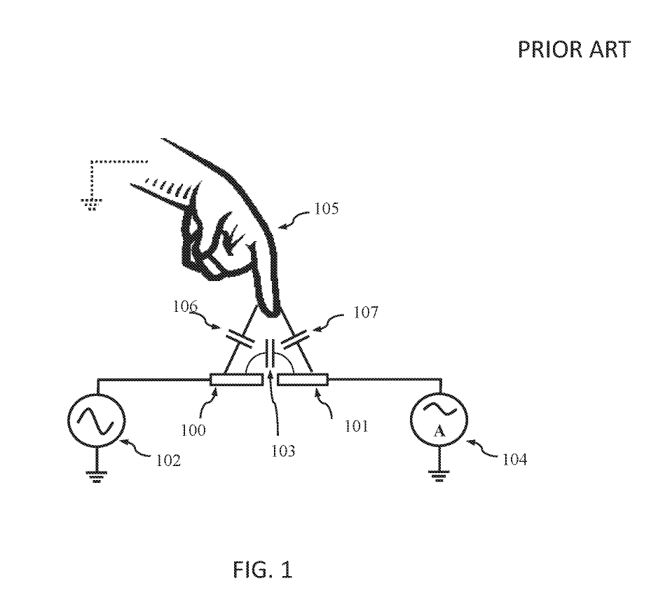

With reference to FIG. 1, an electrode assigned as a drive electrode may be connected to a drive voltage 102. An electrode assigned as a sense electrode may be connected to a current measurement unit 104. With reference to FIG. 4, the drive voltage 102 may be generated by the measurement/processing unit 405 within the touch panel controller 403. Similarly, the current measurement unit 104 may be contained within the measurement/processing unit 405 within the touch panel controller 403.

The connection between the electrodes and the measurement/processing unit 405 is controlled by the multiplexer unit 404. This may be contained within the touch panel controller 403, as shown in the embodiment of FIG. 4, or may be separate from it.

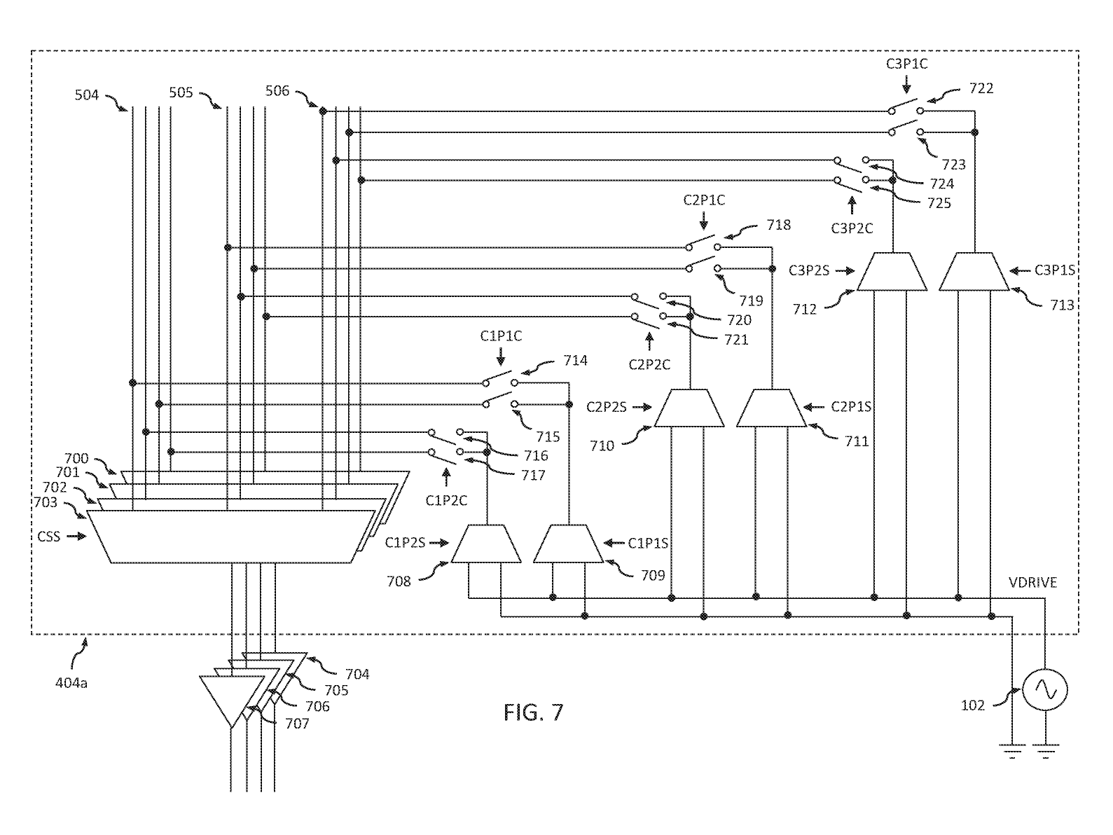

FIG. 7 shows a preferred embodiment, 404a, of the multiplexer unit 404, which is part of the touch panel controller 403. This multiplexer embodiment may be used with the electrode embodiment of FIG. 5 or FIG. 6, for example. FIG. 7 also shows elements of the touch panel controller measurement/processing unit 405. Generally, each electrode that is assignable as a sense electrode may have a separate electrical connection to the controller. In exemplary embodiments, every electrode in the two dimensional array has a separate electrical connection to the controller.

In this embodiment of FIG. 7, the connecting lines, 504, 505, and 506, from each column of electrodes are connected to multiplexers 700, 701, 702, and 703, as shown in FIG. 7. The multiplexers are controlled by the digital signal CSS, and the output of the multiplexers is connected to charge amplifiers 704, 705, 706, and 707. The measurement/processing unit 405 can set the value of CSS to control the multiplexers.

For example, in this embodiment, one value of CSS causes the multiplexers to connect the first column of connecting lines 504 to the amplifiers 704, 705, 706, and 707. The controller therefore senses the first column of electrodes. Another value of CSS causes the multiplexers to connect the second column of connecting lines 505 to the amplifiers. The controller therefore senses the second column of electrodes. Another value of CSS causes the multiplexers to connect the third column of connecting lines 506 to the amplifiers. The controller therefore senses the third column of electrodes.

In this embodiment, the connecting lines are also connected to a set of switches and multiplexers that allow electrodes to be connected to a drive signal or to ground. Methods of implementing suitable switches are well-known in the prior art. For example, the switches may be made from CMOS transistors. The connecting lines 504 from the first column of electrodes are connected to switches 714, 715, 716, and 717 as shown in FIG. 7.

The first and third of the connecting lines 504, corresponding to odd numbered electrode rows, are connected to switches 714 and 715. The switches 714 and 715 are controlled by control signal C1P1C, which is generated by the measurement/processing unit 405. One value of C1P1C causes the switches 714 and 715 to be closed, and another value of C1P1C causes the switches 714 and 715 to be open. The outputs of switches 714 and 715 are connected together, and connected to the input of multiplexer 709. The multiplexer 709 is controlled by digital control signal C1P1S, which is generated by the measurement/processing unit 405. One value of C1P1S causes the input of multiplexer 709 to be connected to ground, and another value of C1P1S causes the input of multiplexer 709 to be connected to a drive voltage, 102 (VDRIVE).

In this embodiment, the electrodes in odd numbered rows in the first column may therefore all be connected to the drive voltage 102, or they may all be connected to ground. Alternatively, they may not be connected to the drive voltage 102 and not connected to ground. The state of these connections is controlled by the measurement/processing unit 405.

The second and fourth of the connecting lines 504, corresponding to even numbered electrode rows, are connected to switches 716 and 717. The switches 716 and 717 are controlled by control signal C1P2C, which is generated by the measurement/processing unit 405. One value of C1P2C causes the switches 716 and 717 to be closed, and another value of C1P2C causes the switches 716 and 717 to be open. The outputs of switches 716 and 717 are connected together, and connected to the input of multiplexer 708. The multiplexer 708 is controlled by digital control signal C1P2S, which is generated by the measurement/processing unit 405. One value of C1P2S causes the input of multiplexer 708 to be connected to ground, and another value of C1P2S causes the input of multiplexer 708 to be connected to a drive voltage, 102 (VDRIVE).

In this embodiment, the electrodes in even numbered rows in the first column may therefore all be connected to the drive voltage 102, or they may all be connected to ground. Alternatively, they may not be connected to the drive voltage 102 and not connected to ground. The state of these connections is controlled by the measurement/processing unit 405.

In this embodiment, the odd and even numbered connecting lines of the connecting line groups 505 and 506 are similarly connected to switches 718, 719, 720, 721, 722, 723, 724, and 725, which are controlled by digital control signals C2P1C, C2P2C, C3P1C, and C3P2C generated by the measurement/processing unit 405. The outputs of these switches are in turn connected to multiplexers 710, 711, 712, and 713, which are controlled by digital control signals C2P1S, C2P2S, C3P1S, and C3P2S generated by the measurement/processing unit 405.

At any given time, in this embodiment, the multiplexer unit 404a, which is controlled by the measurement/processing unit 405, can therefore connect the electrodes from one of the columns of electrodes to amplifiers 704, 705, 706, and 707. These electrodes can then be used as sense electrodes. At any given time, in this embodiment, the multiplexer unit 404a, which is controlled by the measurement/processing unit 405, can therefore also connect one or more electrode groups to a drive signal 102 or to ground, where each electrode group consists of the electrodes in the odd numbered rows of one column, or the even numbered rows of one column. This allows this embodiment of the controller 403 to assign various different groups of electrodes as drive or sense electrodes in order to achieve many of the electrode “patterns” disclosed below. Note that the specific assignment of drive and sense electrodes will be referred to as the electrode “pattern”.

It will be understood to a person of ordinary skill in the art that many other multiplexer architectures are possible, and that different architectures will enable different electrode patterns to be achieved. Some further examples of possible multiplexer architectures are described below.

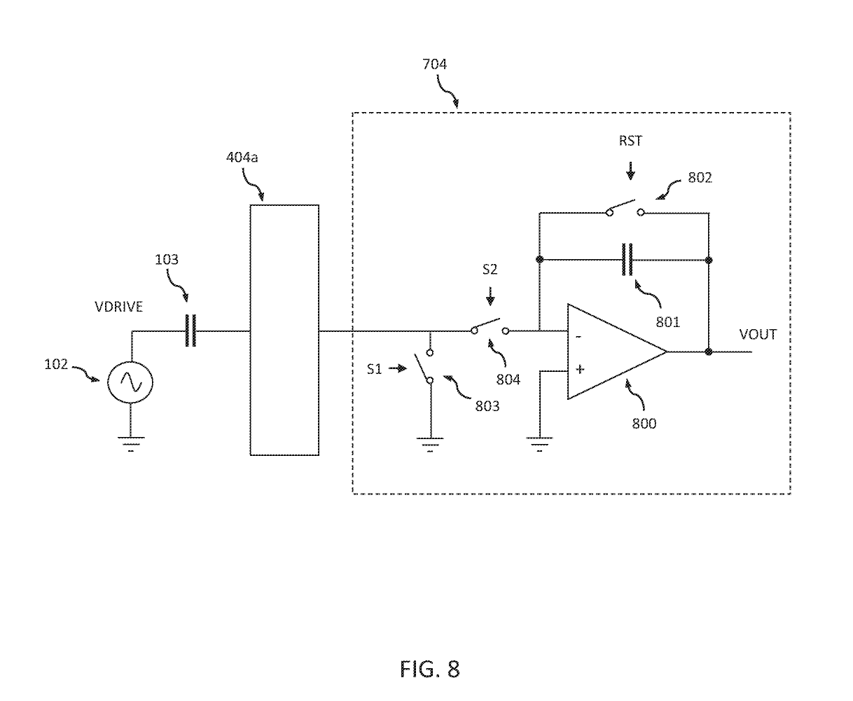

FIG. 8 shows one possible embodiment of the amplifiers 704, 705, 706, and 707 (FIG. 8 identifies only amplifier 704, but a comparable configuration may be employed for amplifiers 705, 706, and 707). These amplifiers form part of the current measurement means 104. With reference to FIG. 8, the drive signal 102 is applied to a drive electrode and coupled via the mutual capacitance 103 to a sense electrode, which is connected via the multiplexer unit 404a to the amplifier 704.

The amplifier circuit described herein is provided as an example of a capacitance measurement circuit using a charge transfer technique as is well-known in the field. Alternatively, other known circuits and techniques for capacitance measurement may be used. A voltage pulse generator 102 supplies drive voltage pulses to an active drive electrode, whilst the charge amplifier circuit 704 holds a sense electrode at a constant voltage. Such a charge amplifier circuit 704 will be well known to one skilled in the art, and typically comprises an operational amplifier 800, an integration capacitor 801 and a reset switch 802. The charge integrator circuit 704 additionally has a first input switch 803 and a second input switch 804, which are operated so as to accumulate charge onto the integration capacitor 801 over the course of one or more drive voltage pulses. The amount of charge accumulated on the integration capacitor is indicative of the mutual capacitance between the active drive electrode and the sense electrode.

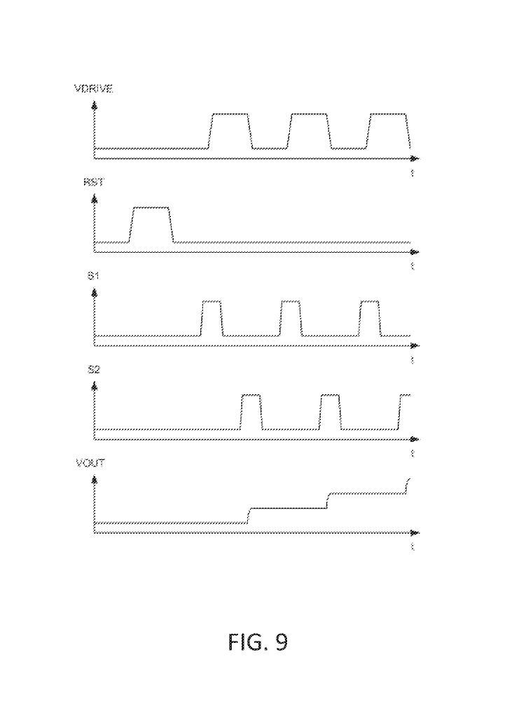

The operation of the capacitance measurement circuit shown in FIG. 8 is now described with reference to the waveform diagram of FIG. 9. The reset switch 802 is firstly closed under the control of a reset switch control signal RST so that the output voltage VOUT begins at a known voltage, such as the system ground potential. The first input switch 803 is then closed under the control of a first input switch control signal S1. The voltage pulse generator 102 now raises the voltage of the drive electrode to a high voltage level and the input of the charge integrator is maintained at a constant level by the first input switch 803. Next, the input switch 803 is opened and the second input switch 804 is closed under the control of a second input switch control signal S2. The voltage pulse generator 102 now returns the voltage of the drive electrode to a low voltage level causing charge to be injected across the mutual capacitance 103 and accumulate on the integration capacitor 801. This causes the output voltage of the charge amplifier circuit to rise by an amount that corresponds to the mutual capacitance 103 between the drive electrode and the sense electrode. This operation of applying a voltage pulse to the drive electrode and cycling the first and second input switches may be repeated many times in order to generate a measurable voltage at the output of the integration circuit.

The final output voltages of the charge amplifiers 704, 705, 706, and 707 may be measured using an analogue to digital converter, in order to generate a digital representation corresponding to the measured mutual capacitance.

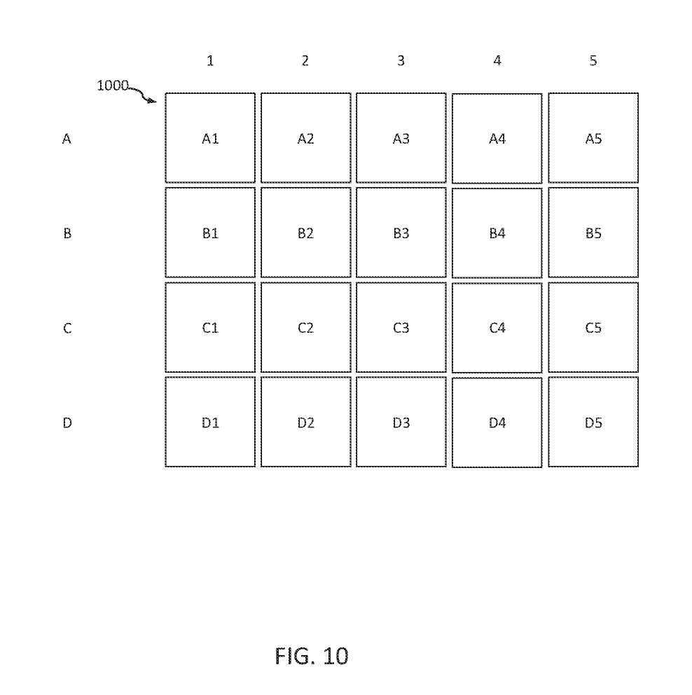

FIG. 10 shows a simplified representation of a two dimensional electrode array. The array includes twenty electrodes 1000, with four electrodes arranged in a first direction and five electrodes arranged in a second direction. Each electrode 1000 is separately connected to a controller. This electrode array may be implemented using the embodiment of FIG. 5 or the embodiment of FIG. 6 or using another embodiment. The electrodes are labelled from A1 to D5. These labels will be used to refer to the electrodes in the following description. The electrode array includes five “columns” of electrodes and four “rows” of electrodes.

Some examples of electrode patterns that are used by certain embodiments of this invention will now be described. Many other suitable electrode patterns can also be used.

Generally, the present invention may be configured as follows in exemplary embodiments. A touch panel device includes a two dimensional array of electrodes comprising a plurality of electrodes, and a controller electrically coupled to the two dimensional array of electrodes. A first portion of the electrodes are assignable by the controller as drive electrodes or unused electrodes, and a second portion of the electrodes are assignable by the controller as sense electrodes or unused electrodes. The controller is configured to: assign drive electrodes and sense electrodes during a plurality of measurement periods, wherein a pattern of assigned drive electrodes and sense electrodes is different during different measurement periods, and the assigned drive electrodes and sense electrodes form mutual capacitances over a plurality of coupling distances during the plurality of measurement periods; measure mutual capacitances formed between the drive electrodes and the sense electrodes during the measurement periods; and detect and determine a position of an object that is touching or in close proximity to the touch panel device based on the measured mutual capacitances. The touch panel device may then perform a function in response to the object being touching or in close proximity to the touch panel device.

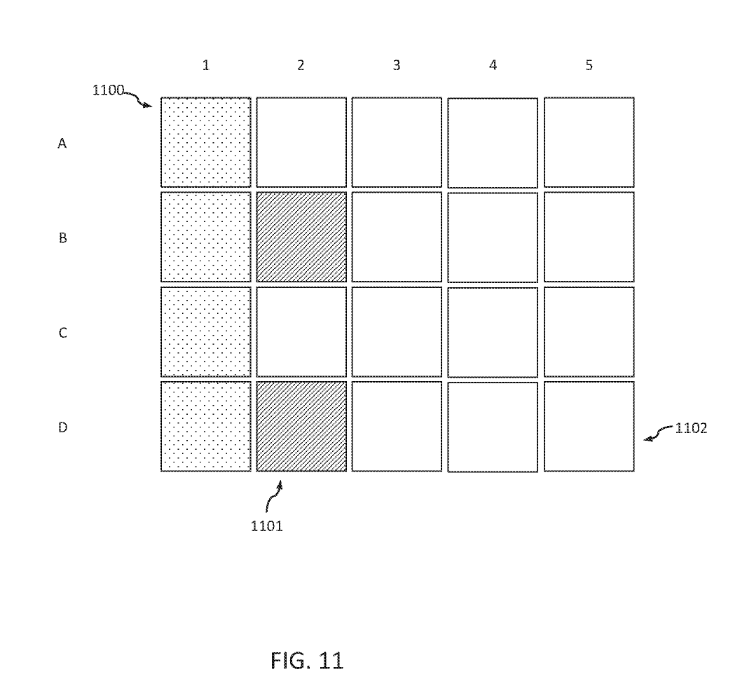

The patterns which can be implemented depend on the specific embodiments of the electrode array and the multiplexer unit. The electrode pattern embodiments of FIGS. 11-25 can be implemented using the electrode array embodiments of FIG. 5 or FIG. 6, and the multiplexer embodiment of FIG. 7, for example. Many different electrode patterns can be implemented using different electrode array and multiplexer embodiments.

FIG. 11 shows an exemplary electrode assignment that may be used during a first measurement period. This pattern includes sense electrodes 1100, drive electrodes 1101, and unused electrodes 1102 as indicated by the differences in shading in the figure.

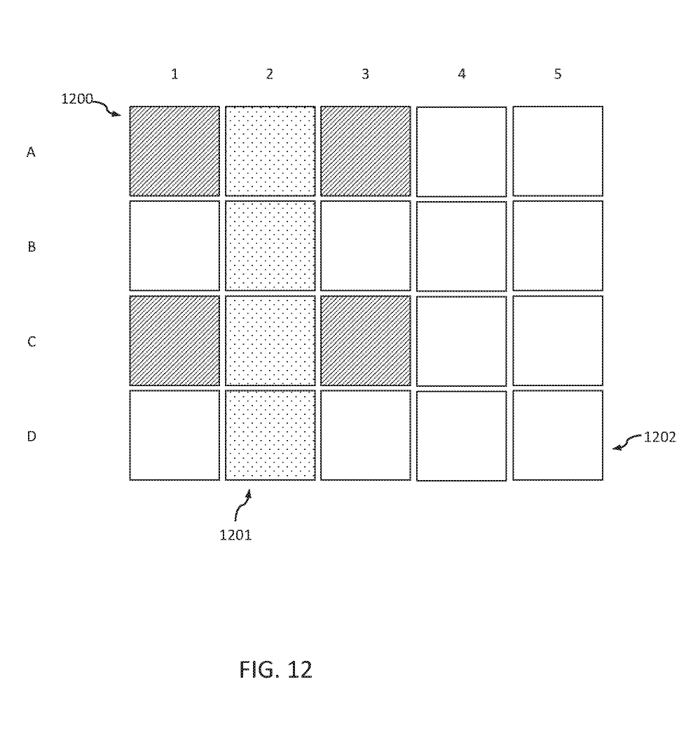

FIG. 12 shows another exemplary electrode assignment that may be used during a second measurement period. This pattern includes drive electrodes 1200, sense electrodes 1201, and unused electrodes 1202 again as indicated by the differences in shading in the figure.

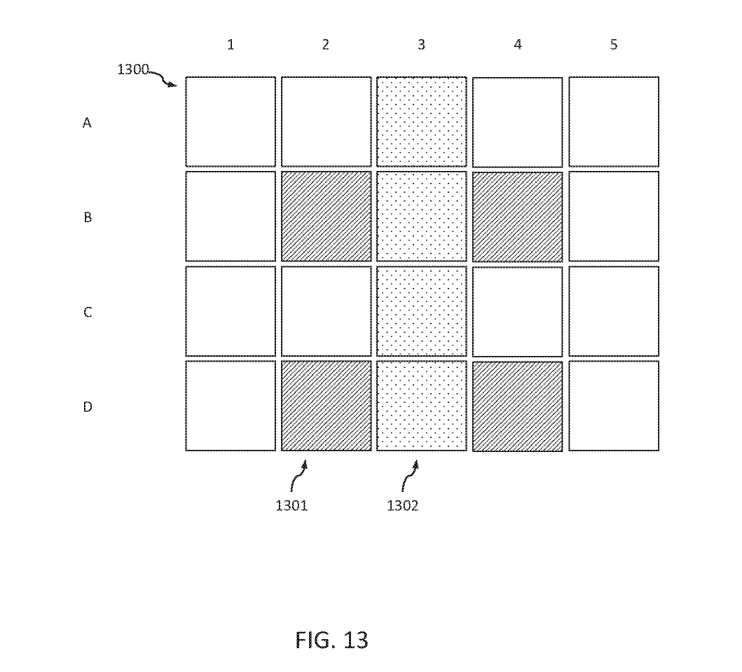

FIG. 13 shows another exemplary electrode assignment that may be used during a third measurement period. This pattern includes unused electrodes 1300, drive electrodes 1301, and sense electrodes 1302 again as indicated by the differences in shading in the figure.

The assigned drive electrodes and sense electrodes form mutual capacitances over a plurality of coupling distances during the plurality of measurement periods. The plurality of coupling distances comprises a short coupling distance and a long coupling distance.

As used herein, generally a “short coupling distance” is defined as a coupling distance between a drive electrode and a sense electrode which are substantially adjacent. A “long coupling distance” is defined as a coupling distance between a drive electrode and a sense electrode which are not substantially adjacent. Note that small structures (for example narrow dummy electrodes or grounded electrodes or connecting lines) may be disposed in the small gap between substantially adjacent electrodes, and so the terms “adjacent” and “substantially adjacent” are intended to encompass the presence of such minor structures in gaps between the electrodes. Electrodes that are separated by an additional drive, sense, or unused electrode in at least one direction may be considered “not adjacent” or “non-adjacent” electrodes.

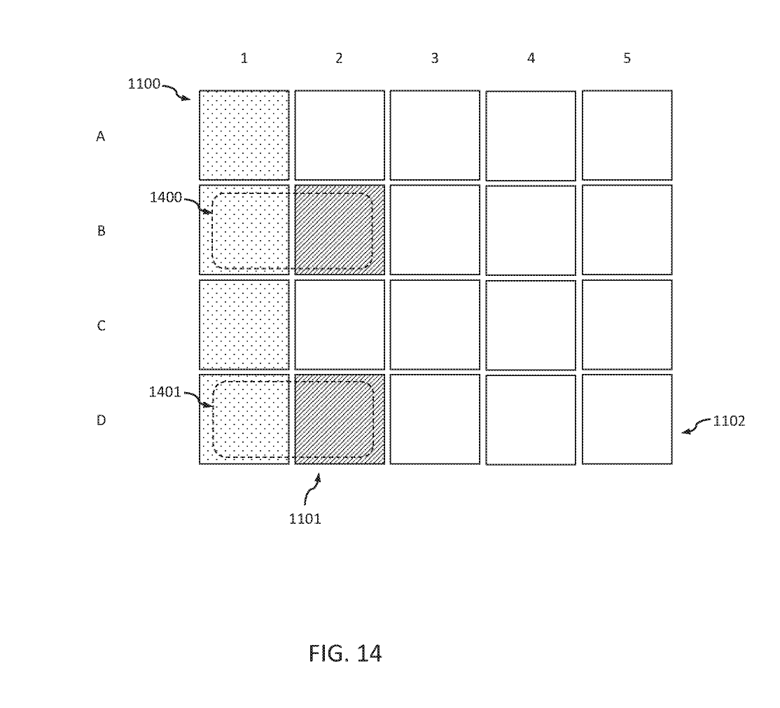

FIG. 14 shows the electrode assignment of FIG. 11, and also shows the approximate region 1400 in which a mutual capacitance is formed between drive electrode B2 and sense electrode B1 over a short coupling distance. The value of the mutual capacitance is affected by any objects present in the approximate region 1400. FIG. 14 further shows the approximate region 1401 in which a mutual capacitance is formed between drive electrode D2 and sense electrode D1 over a short coupling distance. The value of the mutual capacitance is affected by any objects present in the approximate region 1401.

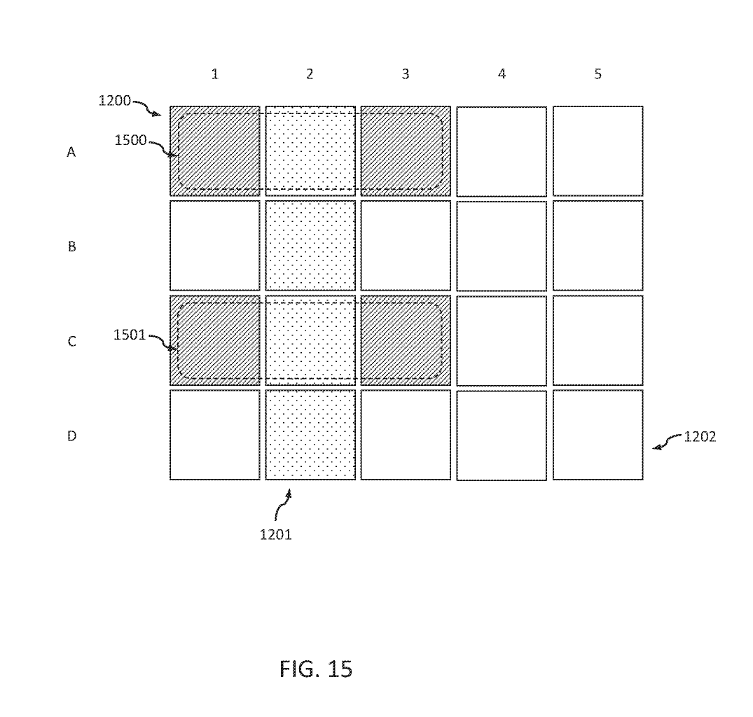

FIG. 15 shows the electrode assignment of FIG. 12, and also shows the approximate region 1500 in which a mutual capacitance is formed between drive electrodes A1 and A3 and sense electrode A2 over a short coupling distance. The value of the mutual capacitance is affected by any objects present in the approximate region 1500. FIG. 15 further shows the approximate region 1501 in which a mutual capacitance is formed between drive electrodes C1 and C3 and sense electrode C2 over a short coupling distance. The value of the mutual capacitance is affected by any objects present in the approximate region 1501.

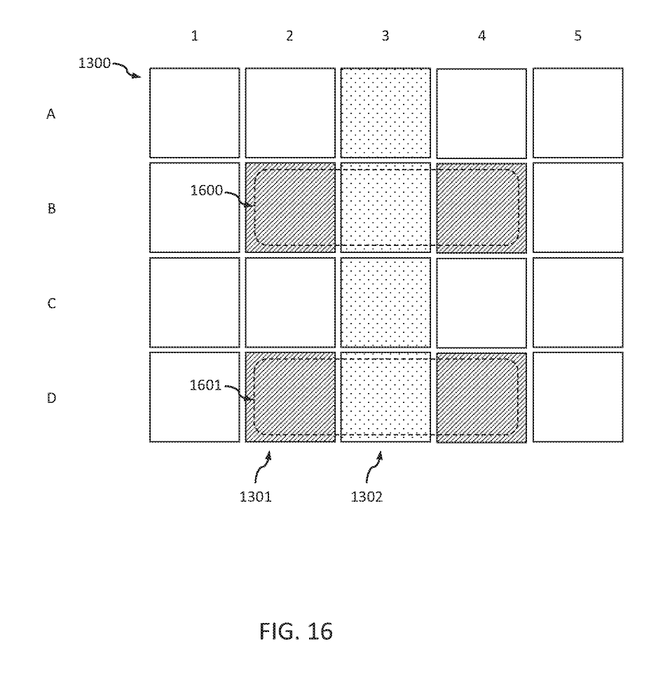

FIG. 16 shows the electrode assignment of FIG. 13, and also shows the approximate region 1600 in which a mutual capacitance is formed between drive electrodes B2 and B4 and sense electrode B3 over a short coupling distance. The value of the mutual capacitance is affected by any objects present in the approximate region 1600. FIG. 16 further shows the approximate region 1601 in which a mutual capacitance is formed between drive electrodes D2 and D4 and sense electrode D3 over a short coupling distance. The value of the mutual capacitance is affected by any objects present in the approximate region 1601.

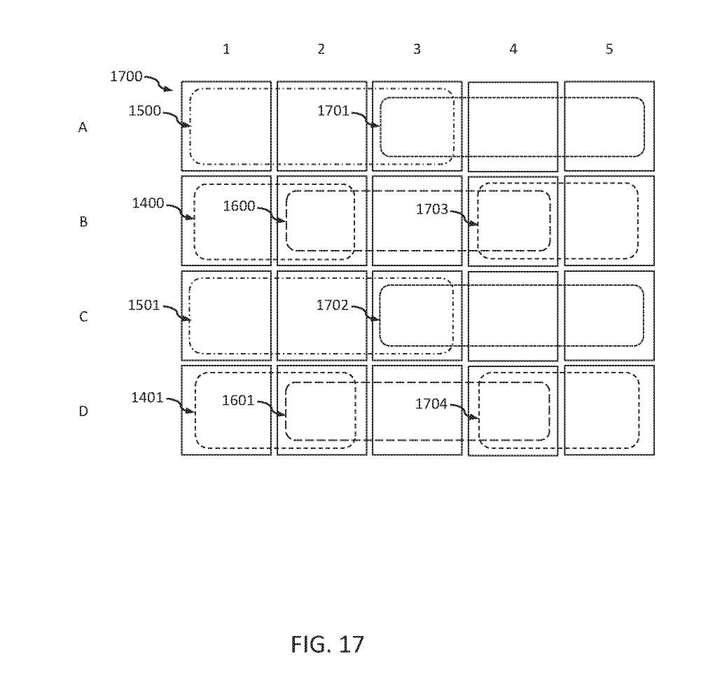

FIG. 17 shows an array of electrodes 1700 and the approximate regions 1400, 1401, 1500, 1501, 1600, and 1601. FIG. 17 also shows additional approximate regions 1701 and 1702, 1703, and 1704. In region 1701 a mutual capacitance is formed between drive electrodes A3 and A5 and sense electrode A4 over a short coupling distance. In region 1702 a mutual capacitance is formed between drive electrodes C3 and C5 and sense electrode C4 over a short coupling distance. In region 1703 a mutual capacitance is formed between drive electrode B4 and sense electrode B5 over a short coupling distance. In region 1704 a mutual capacitance is formed between drive electrode D4 and sense electrode D5 over a short coupling distance. Electrode assignments that result in sensitive regions 1700 and 1701 may be used in a fourth measurement period, and electrode assignments that result in sensitive regions 1702 and 1703 may be used in a fifth measurement period.

FIG. 17 shows that the regions collectively cover the whole surface of the panel over the different measurement periods. Measurements are therefore made which are sensitive to the presence of an object touching or in close proximity to any point on the panel surface. FIG. 17 further shows that many of the regions overlap. By using interpolation, the location of an object can therefore be determined with good accuracy. Suitable interpolation methods are well known in the prior art.

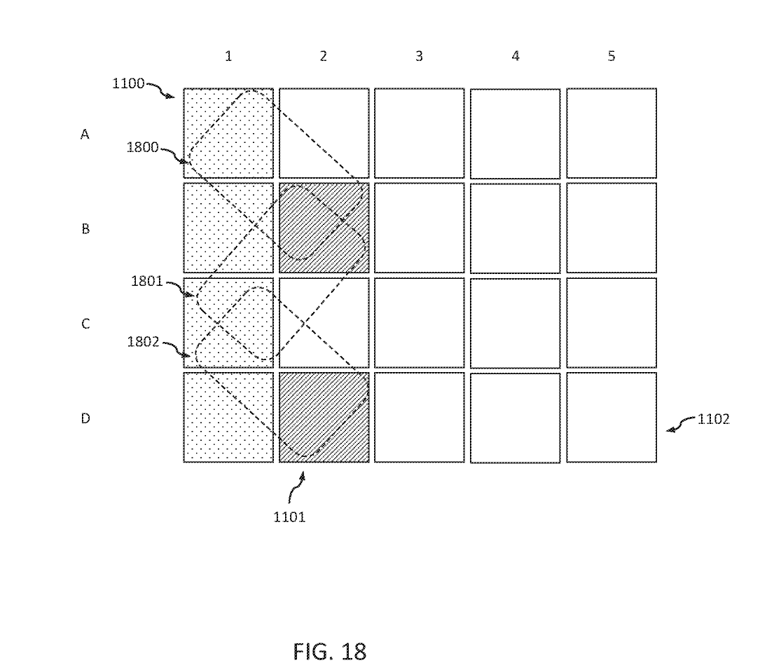

FIG. 18 shows the electrode assignment of FIG. 11, and also shows the approximate region 1800 in which a mutual capacitance is formed between drive electrode B2 and sense electrode A1 over a long coupling distance. The value of the mutual capacitance is affected by any objects present in the approximate region 1800. FIG. 18 further shows the approximate regions 1801 and 1802 in which a mutual capacitance is formed between drive electrodes B2 and D2 and sense electrode C1 over long coupling distances. The value of the mutual capacitance is affected by any objects present in the approximate regions 1801 and 1802.

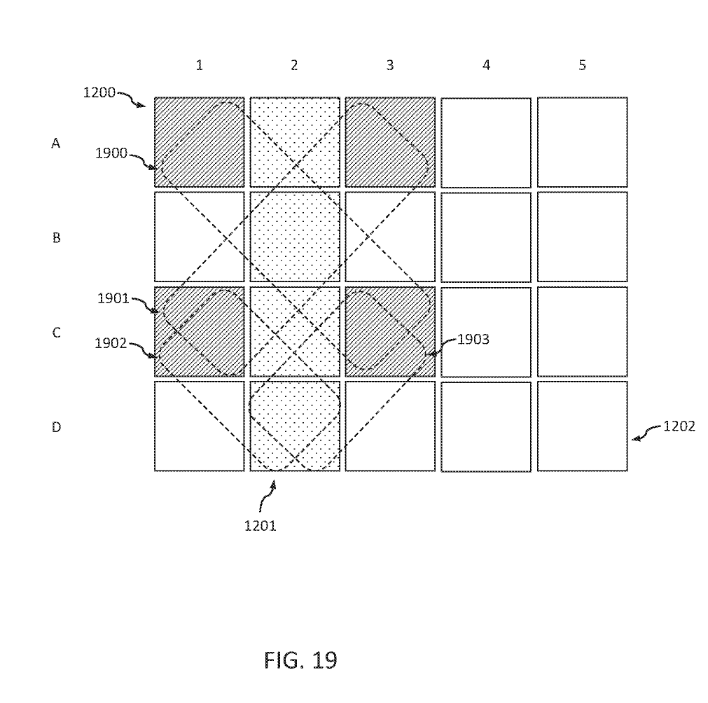

FIG. 19 shows the electrode assignment of FIG. 12, and also shows the approximate regions 1900 and 1901 in which a mutual capacitance is formed between drive electrodes A1, A3, C1, and C3 and sense electrode B2 over long coupling distances. The value of the mutual capacitance is affected by any objects present in the approximate regions 1900 and 1901. FIG. 19 further shows the approximate regions 1902 and 1903 in which a mutual capacitance is formed between drive electrodes C1 and C3 and sense electrode D2 over long coupling distances. The value of the mutual capacitance is affected by any objects present in the approximate regions 1902 and 1903.

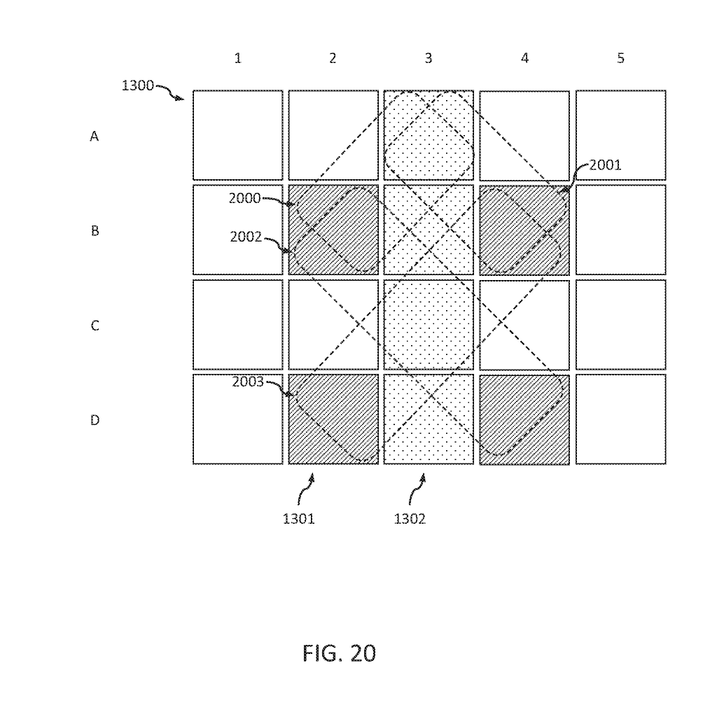

FIG. 20 shows the electrode assignment of FIG. 13, and also shows the approximate regions 2000 and 2001 in which a mutual capacitance is formed between drive electrodes B2 and B4 and sense electrode A3 over long coupling distances. The value of the mutual capacitance is affected by any objects present in the approximate regions 2000 and 2001. FIG. 20 further shows the approximate regions 2002 and 2003 in which a mutual capacitance is formed between drive electrodes B2, B4, D2, and D4 and sense electrode C3 over long coupling distances. The value of the mutual capacitance is affected by any objects present in the approximate regions 2002 and 2003.

Electrode patterns may be used in a fourth measurement period and a fifth measurement period that result in additional mutual capacitances, formed over long coupling distances, with different approximate sensitive regions.

It is possible to choose regions which collectively cover the whole surface of the panel over the different measurement periods. Measurements are therefore made which are sensitive to the presence of an object touching or in close proximity to any point on the panel surface. It is also clear that many of the regions overlap. By using interpolation, the location of an object can therefore be determined with good accuracy. Suitable interpolation methods are well known in the prior art.

In each of the five electrode assignment configurations as assigned by the controller, two sense electrodes are directly adjacent to at least one drive electrode and are not diagonally adjacent to any drive electrodes. A mutual capacitance is therefore formed between the drive and sense electrodes over short coupling distances. In each of the five electrode assignment configurations, two sense electrodes are also diagonally adjacent to at least one drive electrode and are not directly adjacent to any drive electrodes. A mutual capacitance is therefore formed between the drive and sense electrodes over a long coupling distance. This beneficially forms multiple coupling capacitances over different coupling distances within each measurement period.

For any pair of drive and sense electrodes that form a mutual coupling capacitance over a long coupling distance, an electrode assigned as a sense electrode in a first configuration during a first measurement period is assigned as a drive electrode in a second configuration during a second measurement period. For any pair of drive and sense electrodes which form a mutual coupling capacitance over a short coupling distance, an electrode assigned as a sense electrode in the first configuration during the first measurement period is assigned as an unused electrode in the second configuration during the second measurement period.

Each electrode is therefore assigned as a sense electrode exactly once. Each electrode that is not an edge electrode in column 1 or column 5 is also assigned as a drive electrode exactly two times or exactly zero times.

In this way, a number of mutual capacitances are formed over both short and long coupling distances with sensitive regions that cover the whole touch panel over the different measurement periods, while requiring the minimum number of measurements to be made and while obtaining the maximum possible spatial and temporal resolution.

In an embodiment using the electrode assignments of FIGS. 11-20, two sets of data are generated. The first set of data, shown in FIG. 17, corresponds to measurements of mutual capacitance over short coupling distances. The second set of data, shown in part in FIGS. 18-20, corresponds to measurements of mutual capacitance over long coupling distances. Both sets of data include sensitive regions that collectively cover the whole surface of the panel over the different measurement periods. Some of the sensitive regions have different sizes and shapes. The data sets may be processed to make the first data set and the second data set more directly comparable. This processing may include changing the resolution of the data, and performing interpolation, scaling, and other well-known algorithmic techniques.

The two data sets therefore contain measurements of multiple mutual capacitances formed over different coupling distances. The data sets are used to detect conductive and non-conductive objects that may be touching or in close proximity to any point on the surface of the touch panel.

The two data sets may also be used to determine whether an object that is touching or in close proximity to any point on the surface of the touch panel is a conductive object or a non-conductive object. Conductive objects may be detected and identified based on a first characteristic change in the multiple mutual capacitances formed over different coupling distances. Non-conductive objects may be detected and identified based on a second characteristic change in the multiple mutual capacitances formed over different coupling distances.

For example, in some embodiments the first characteristic change is a decrease in the value of one or more mutual capacitances formed over short distances and a decrease in the value of one or more mutual capacitances formed over long distances. In some embodiments the second characteristic change is a decrease in the value of one or more mutual capacitances formed over short distances and an increase in the value of one or more mutual capacitances formed over long distances. The characteristic change may be similar to those disclosed in U.S. Pat. No. 9,105,255 (Brown et al, issued Aug. 11, 2015).

The two data sets may further be used to determine the height of an object that is in close proximity to any point on the surface of the touch panel based on characteristic changes in the multiple mutual capacitances formed over different coupling distances. In some embodiments, a mutual capacitance formed between two electrodes over a short coupling distance exhibits large changes when an object is brought into close proximity to the electrodes, whereas a mutual capacitance formed between two electrodes over a long coupling distance exhibits smaller changes when an object is brought into close proximity to the electrodes. In some embodiments, a mutual capacitance formed between two electrodes over a short coupling distance exhibits small changes when an object is held at a significant distance above the electrodes, whereas a mutual capacitance formed between two electrodes over a long coupling distance exhibits larger changes when an object is held at a significant distance above the electrodes.

In some embodiments, the controller can therefore determine the height of an object above the surface of the touch panel by comparing the changes in the measured mutual capacitances formed over short coupling distances with the changes in the measured mutual capacitances formed over long coupling distances. For example, in some embodiments the controller may calculate the ratio of the changes in the capacitances formed over short coupling distances and the capacitances formed over long coupling distances. Suitable methods are disclosed in US 2014/0,009,428 (Brown et al, published January 2014).

FIG. 17 indicates that the electrode assignments used in this embodiment result in a lower effective spatial resolution at the left and right edges of the panel (column number 1 and column number 5). In some embodiments, additional measurements may be made using additional electrode assignments in order to improve the effective spatial resolution at the edge of the panel.

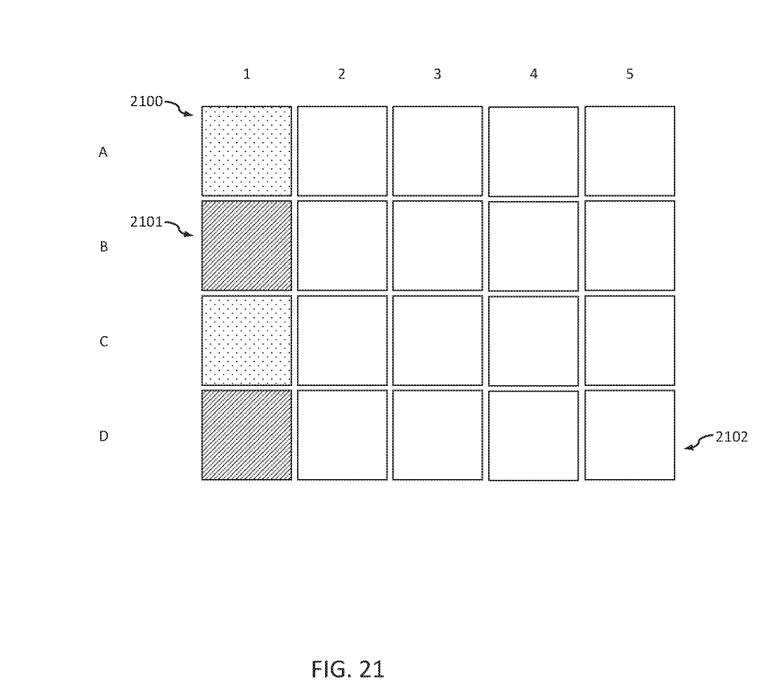

FIG. 21 shows an exemplary electrode assignment that may be used during a sixth measurement period. This pattern includes sense electrodes 2100, drive electrodes 2101, and unused electrodes 2102.

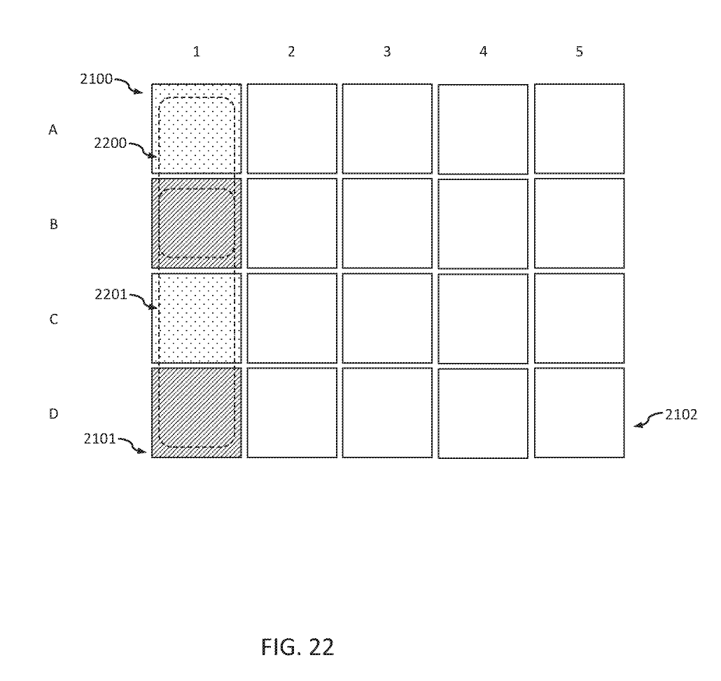

FIG. 22 shows the electrode assignment of FIG. 21, and also shows the approximate region 2200 in which a mutual capacitance is formed between drive electrode B1 and sense electrode A1 over a short coupling distance. The value of the mutual capacitance is affected by any objects present in the approximate region 2200. FIG. 22 further shows the approximate region 2201 in which a mutual capacitance is formed between drive electrodes B1 and D1 and sense electrode C1 over a short coupling distance. The value of the mutual capacitance is affected by any objects present in the approximate region 2201.

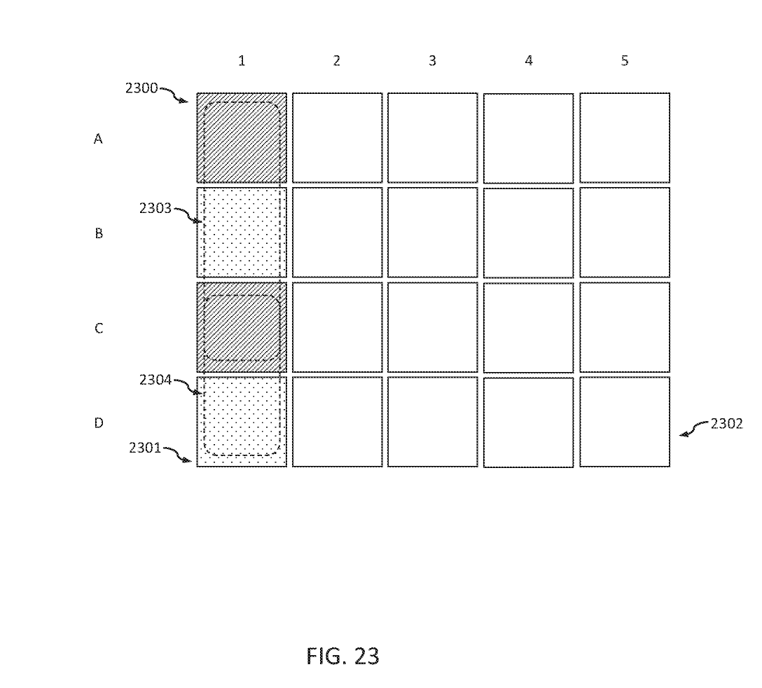

FIG. 23 shows an electrode assignment that may be used during a seventh measurement period. This pattern includes drive electrodes 2300, sense electrodes 2301, and unused electrodes 2302.

FIG. 23 also shows the approximate region 2303 in which a mutual capacitance is formed between drive electrodes A1 and C1 and sense electrode B1 over a short coupling distance. The value of the mutual capacitance is affected by any objects present in the approximate region 2303. FIG. 23 further shows the approximate region 2304 in which a mutual capacitance is formed between drive electrode C1 and sense electrode D1 over a short coupling distance. The value of the mutual capacitance is affected by any objects present in the approximate region 2304.

The measurements corresponding to approximate sensitive regions 2200, 2201, 2303, and 2304 may be combined with the first and second data set in order to improve the effective spatial resolution at the edge of the panel.

Note that the embodiments described above generally use a symmetrical assignment of drive and sense electrodes. However, many other embodiments are possible, including the use of asymmetrical drive and sense electrode assignments.

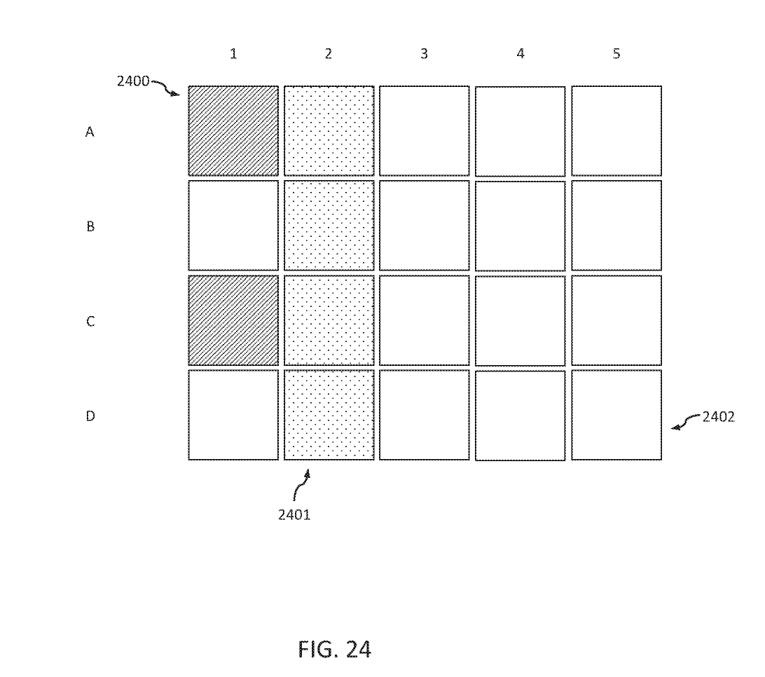

FIG. 24 shows an asymmetrical electrode assignment that may be used during a measurement period, for example during a second measurement period. This pattern includes drive electrodes 2400, sense electrodes 2401, and unused electrodes 2402.

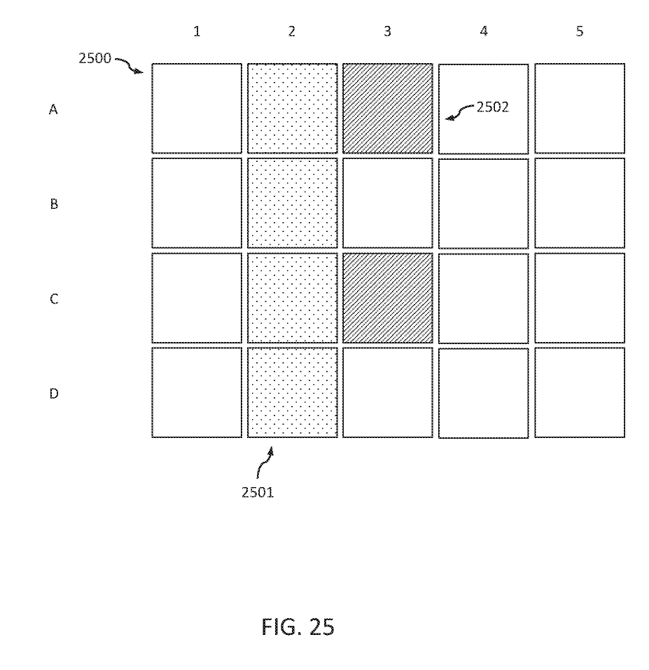

FIG. 25 shows an asymmetrical electrode assignment that may be used during a measurement period, for example during a third measurement period. This pattern includes unused electrodes 2500, sense electrodes 2501, and drive electrodes 2502.

Note also that the embodiments described above generally assign all the electrodes in one column to be sense electrodes during a measurement period, and electrodes in adjacent columns to be drive electrodes. However, many other embodiments are possible.

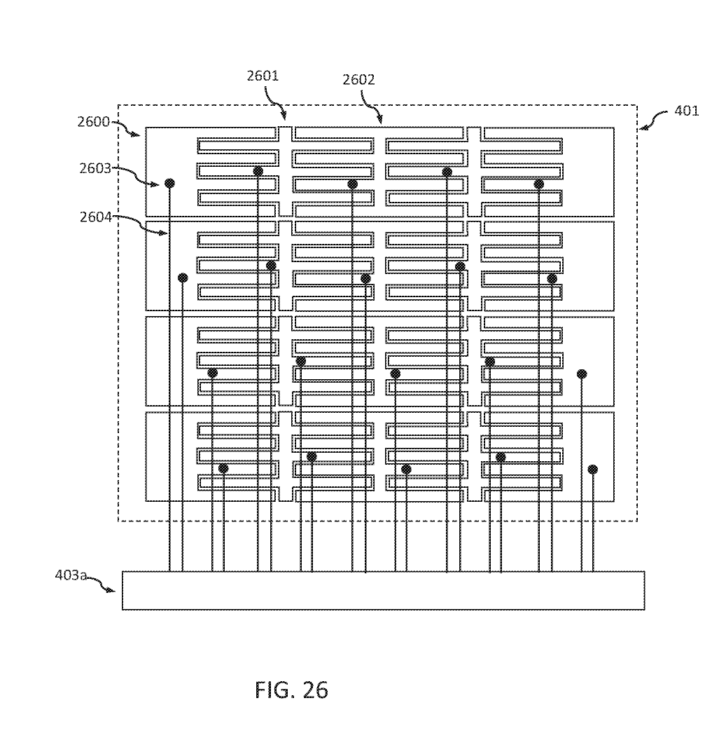

The embodiments of FIG. 5 and FIG. 6 use electrodes that are substantially square or rectangular, but many other electrode geometries are possible. For example, FIG. 26 shows an exemplary embodiment of a touch sensor panel 401 which uses an array of interdigitated electrodes to increase the coupling capacitance between adjacent electrodes in each row. These electrodes are interdigitated in one direction only. Many different electrode geometries can be used to achieve the same effect. The electrode array includes twenty interdigitated electrodes 2600, 2601, and 2602 formed on a first layer, with four electrodes arranged in a first direction and five electrodes arranged in a second direction. Vias 2603 connect each electrode on the first layer to connecting lines 2604 on a second layer. By this means, each electrode is separately connected to a controller 403a.

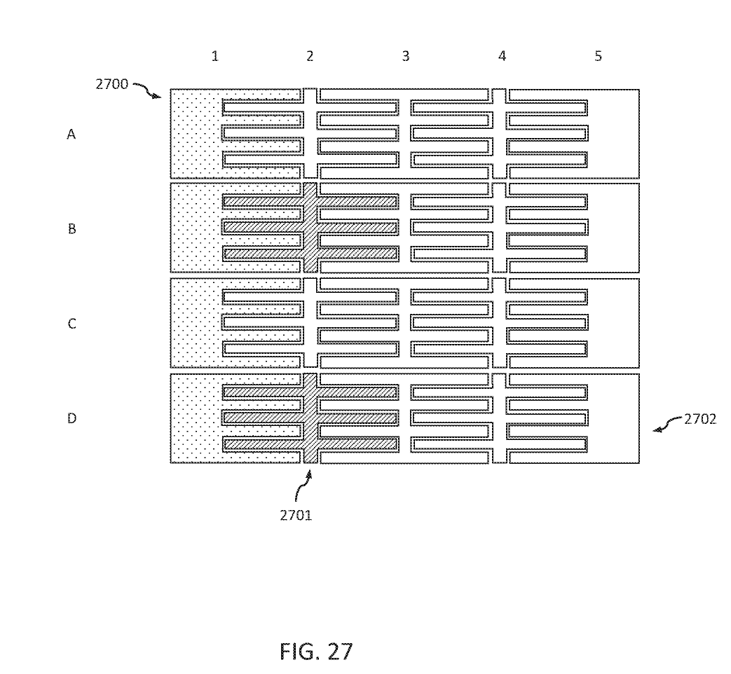

FIG. 27 shows the electrode assignment of FIG. 11 applied to the touch sensor panel embodiment of FIG. 26. FIG. 27 includes sense electrodes 2700, drive electrodes 2701, and unused electrodes 2702.

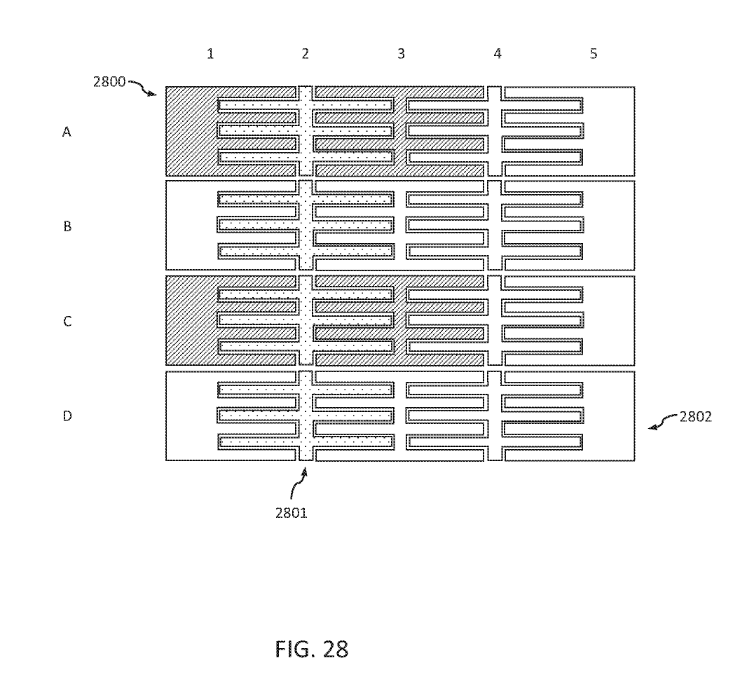

FIG. 28 shows the electrode assignment of FIG. 12 applied to the touch sensor panel embodiment of FIG. 26. FIG. 27 includes drive electrodes 2800, sense electrodes 2801, and unused electrodes 2802.

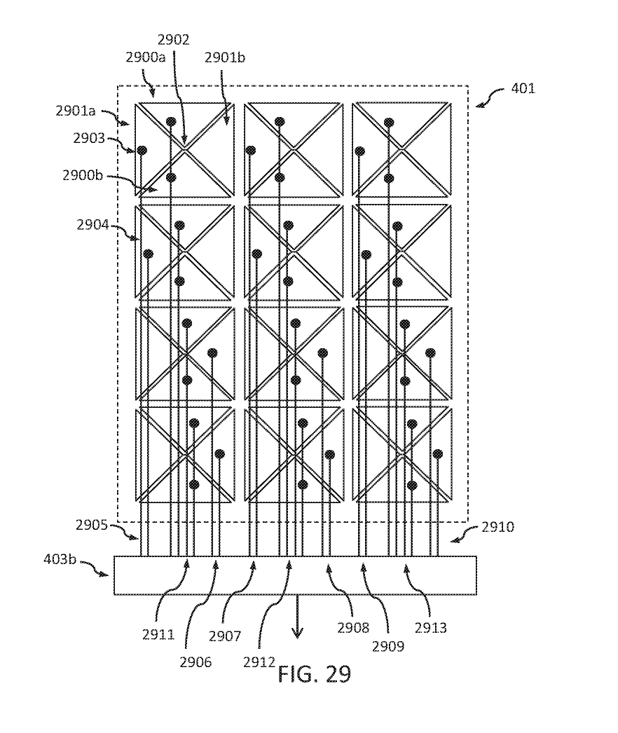

In the embodiments of FIGS. 5-28, each electrode can be assigned as a sense electrode, a drive electrode, or an unused electrode during a measurement period. However, other embodiments are possible for which some electrodes may be assigned as either a drive electrode or an unused electrode, and other electrodes may be assigned as either a sense electrode or an unused electrode. For example, FIG. 29 shows an embodiment of a touch sensor panel 401 which uses an array of electrodes with a diamond geometry. The array includes twelve electrode pairs formed on a first layer, with four electrode pairs arranged in a first direction and three electrode pairs arranged in a second direction. Each electrode pair includes a first electrode 2900 and a second electrode 2901. The first electrode 2900 comprises two parts, 2900a and 2900b, which are electrically connected together. The second electrode 2901 comprises two parts, 2901a and 2901b, which are electrically connected together. In this embodiment, the electrode parts 2901a and 2901b are joined by the connecting feature 2902 which is formed in the first layer. Vias 2903 connect each electrode on the first layer to connecting lines 2904 on a second layer. By this means, each electrode is separately connected to a controller 403b, and an electrical connection is made between electrode parts 2900a and 2900b.

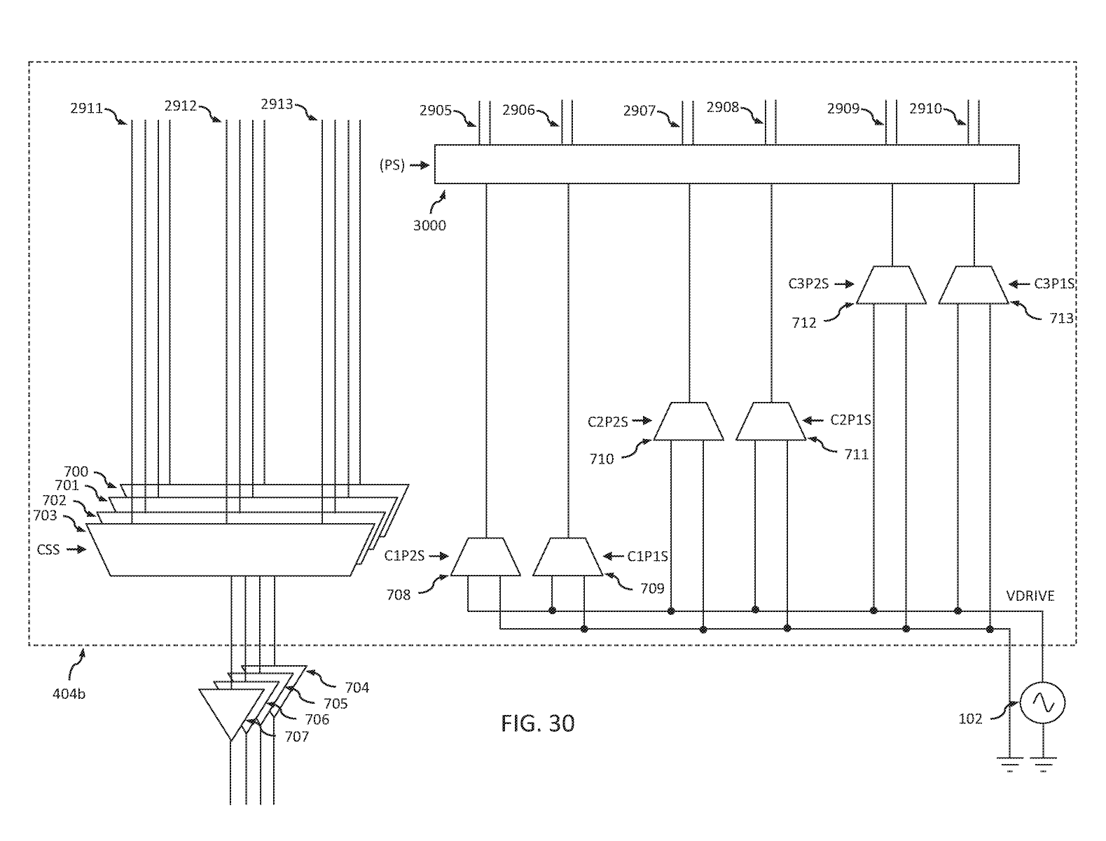

FIG. 30 shows an embodiment, 404b, of the multiplexer unit 404, which is part of the touch panel controller 403. This multiplexer unit embodiment 404b may be used with the electrode embodiment of FIG. 29, for example. FIG. 30 also shows elements of the touch panel controller measurement/processing unit 405.

In this embodiment the connecting lines, 2911, 2912, and 2913, from each column of electrodes 2900 are connected to multiplexers 700, 701, 702, and 703, as shown in FIG. 30. The multiplexers are controlled by the digital signal CSS, and the output of the multiplexers is connected to charge amplifiers 704, 705, 706, and 707. The measurement/processing unit 405 can set the value of CSS to control the multiplexers. For example, in this embodiment, one value of CSS causes the multiplexers to connect the first column of connecting lines 2911 to the amplifiers 704, 705, 706, and 707. The controller therefore senses the first column of electrodes. Another value of CSS causes the multiplexers to connect the second column of connecting lines 2912 to the amplifiers. The controller therefore senses the second column of electrodes. Another value of CSS causes the multiplexers to connect the third column of connecting lines 2913 to the amplifiers. The controller therefore senses the third column of electrodes.

In this embodiment, the connecting lines 2905, 2906, 2907, 2908, 2909, and 2910, from each column of electrodes 2901, are connected to a routing unit 3000. The routing unit 3000 is in turn connected to multiplexers 708, 709, 710, 711, 712, and 713. In some embodiments, the routing unit 3000 may make fixed connections between the connecting lines and the multiplexers. For example, in one embodiment, the two connecting lines 2905 are connected together and connected to multiplexer 708 by the routing unit 3000. In this embodiment, the two connecting lines 2906 are connected together and connected to multiplexer 709 by the routing unit 3000. In this embodiment, the two connecting lines 2907 are connected together and connected to multiplexer 710 by the routing unit 3000. In this embodiment, the two connecting lines 2908 are connected together and connected to multiplexer 711 by the routing unit 3000. In this embodiment, the two connecting lines 2909 are connected together and connected to multiplexer 712 by the routing unit 3000. In this embodiment, the two connecting lines 2910 are connected together and connected to multiplexer 713 by the routing unit 3000. In some embodiments, the routing unit 3000 may contain switches that can change the connections between the connecting lines 2905, 2906, 2907, 2908, 2909, and 2910, and the multiplexers 708, 709, 710, 711, 712, and 713. In these embodiments, the routing unit 3000 is controlled by digital signal PS, which is generated by the measurement/processing unit 405.

The operation of multiplexers 708, 709, 710, 711, 712, and 713 is described in detail above.

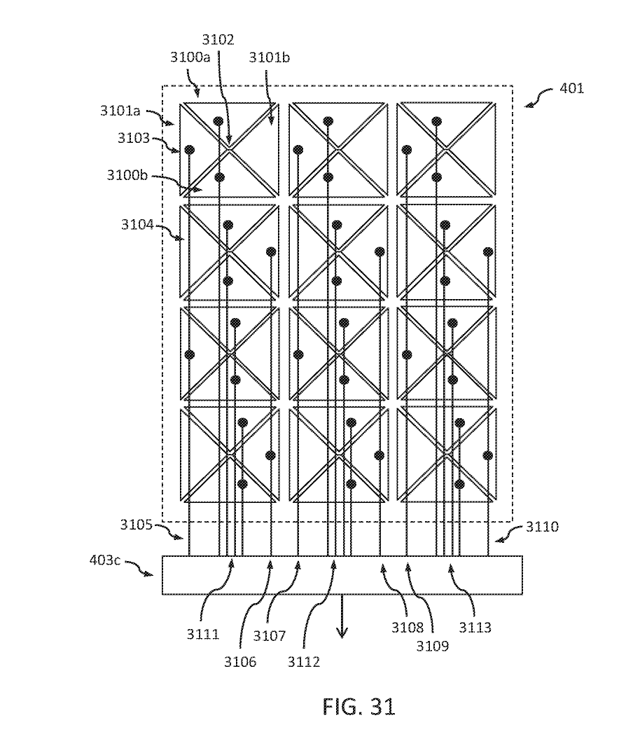

FIG. 31 shows an embodiment of a touch sensor panel 401 which uses an array of electrodes with a diamond geometry. The array includes twelve electrode pairs formed on a first layer, with four electrode pairs arranged in a first direction and three electrode pairs arranged in a second direction. Each electrode pair has a first electrode 3100 and a second electrode 3101. The electrode 3100 comprises two parts, 3100a and 3100b, which are electrically connected together. The electrode 3101 comprises two parts, 3101a and 3101b, which are electrically connected together. In this embodiment, the electrode parts 3101a and 3101b are joined by the connecting feature 3102 which is formed in the first layer. Vias 3103 connect each electrode on the first layer to connecting lines 3104 on a second layer. By this means, each electrode is separately connected to a controller 403c, and an electrical connection is made between electrode parts 3100a and 3100b. In addition, in this embodiment, electrical connections are made between the electrodes 3101 in odd numbered rows by connecting lines 3105, 3107, and 3109. Electrical connections are also made between the electrodes 3101 in even numbered rows by connecting lines 3106, 3108, and 3110.

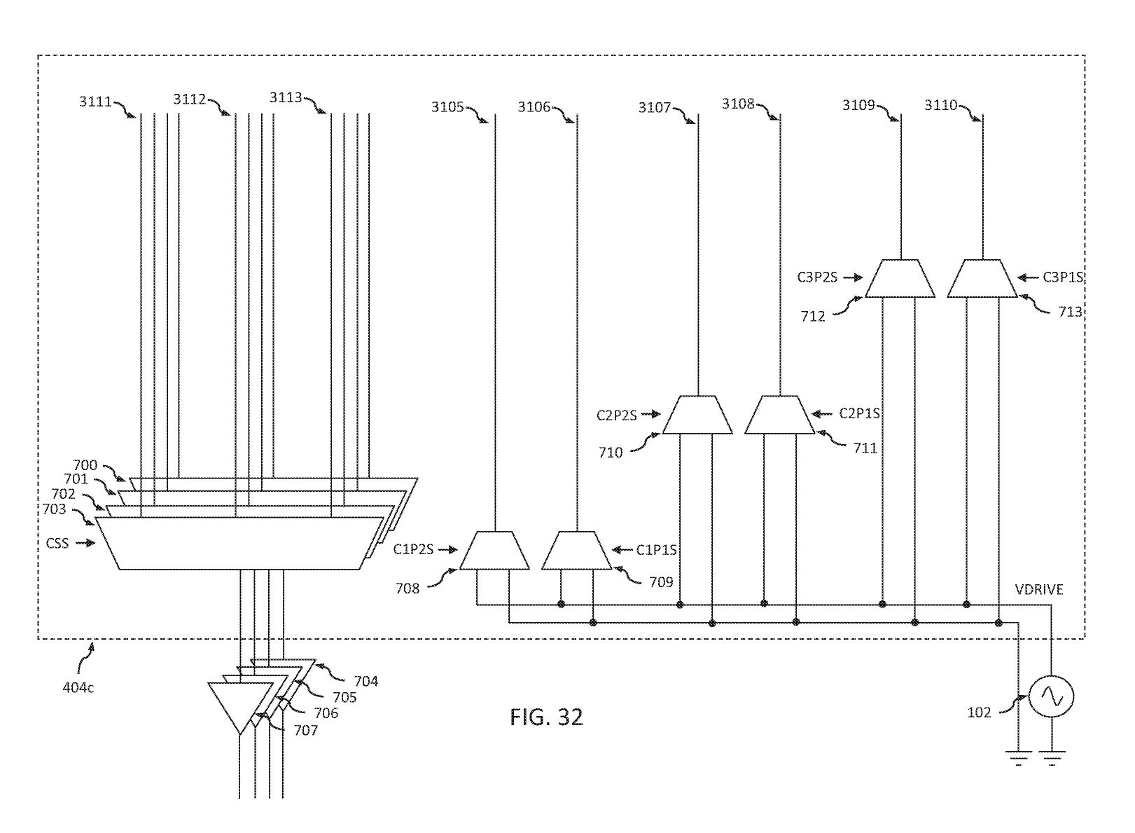

FIG. 32 shows an embodiment, 404c, of the multiplexer unit 404, which is part of the touch panel controller 403. This multiplexer unit embodiment 404c may be used with the electrode embodiment of FIG. 31, for example. FIG. 32 also shows elements of the touch panel controller measurement/processing unit 405.

In this embodiment the connecting lines, 3111, 3112, and 3113, from each column of electrodes 3100, are connected to multiplexers 700, 701, 702, and 703, as shown in FIG. 32. The multiplexers are controlled by the digital signal CSS, and the output of the multiplexers is connected to charge amplifiers 704, 705, 706, and 707. The measurement/processing unit 405 can set the value of CSS to control the multiplexers. For example, in this embodiment, one value of CSS causes the multiplexers to connect the first column of connecting lines 3111 to the amplifiers 704, 705, 706, and 707. The controller therefore senses the first column of electrodes. Another value of CSS causes the multiplexers to connect the second column of connecting lines 3112 to the amplifiers. The controller therefore senses the second column of electrodes. Another value of CSS causes the multiplexers to connect the third column of connecting lines 3113 to the amplifiers. The controller therefore senses the third column of electrodes.

In this embodiment, the connecting line 3105 is connected to the input of multiplexer 708. In this embodiment, the connecting line 3106 is connected to the input of multiplexer 709. In this embodiment, the connecting line 3107 is connected to the input of multiplexer 710. In this embodiment, the connecting line 3108 is connected to the input of multiplexer 711. In this embodiment, the connecting line 3109 is connected to the input of multiplexer 712. In this embodiment, the connecting line 3110 is connected to the input of multiplexer 713.

The operation of multiplexers 708, 709, 710, 711, 712, and 713 is described in detail above.

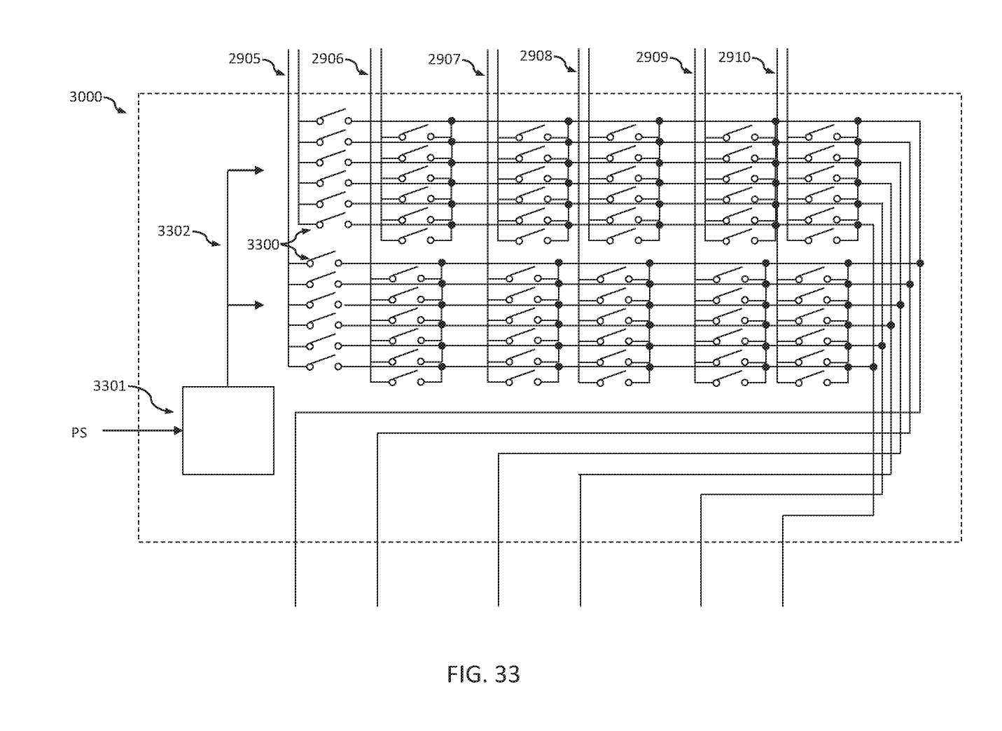

FIG. 33 shows an embodiment of the routing unit 3000 that contains switches that are able to change the connections between the connecting lines 2905, 2906, 2907, 2908, 2909, and 2910, and the multiplexers 708, 709, 710, 711, 712, and 713 in the embodiment of FIG. 30. In this embodiment, an array of switches 3300 are arranged as shown in FIG. 33. Methods of implementing suitable switches are well-known in the prior art. For example, the switches may be made from CMOS transistors. The switches 3300 are controlled by a control unit 3301, which generates switch control signals 3302 in response to input PS. This embodiment therefore allows the routing between the electrodes and the multiplexers 708, 709, 710, 711, 712, and 713 to be changed. This enables additional electrode assignment patterns to be realised.

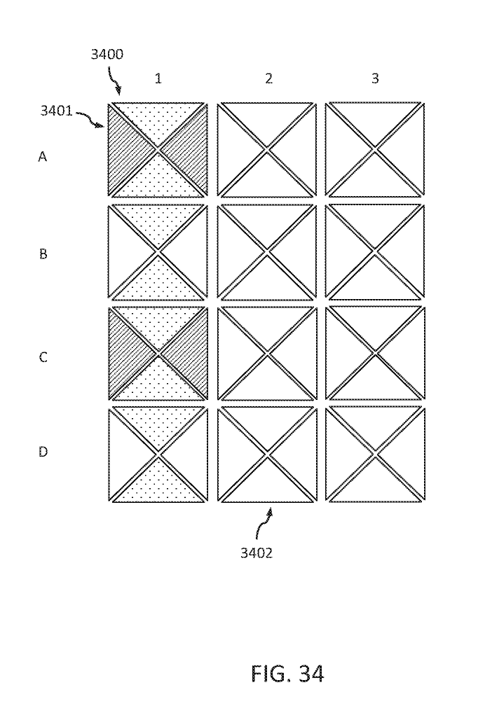

FIG. 34 shows an electrode assignment configuration that may be used with the electrode structure of FIG. 29 or FIG. 31 during a first measurement period. This pattern includes sense electrodes 3400, drive electrodes 3401, and unused electrodes 3402.

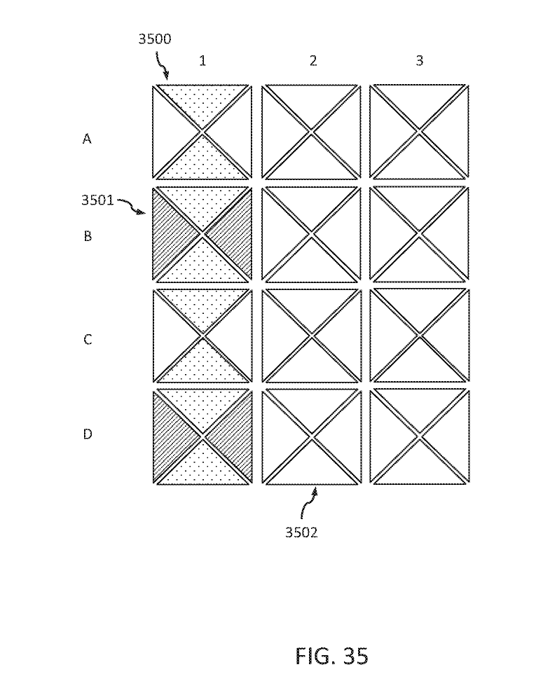

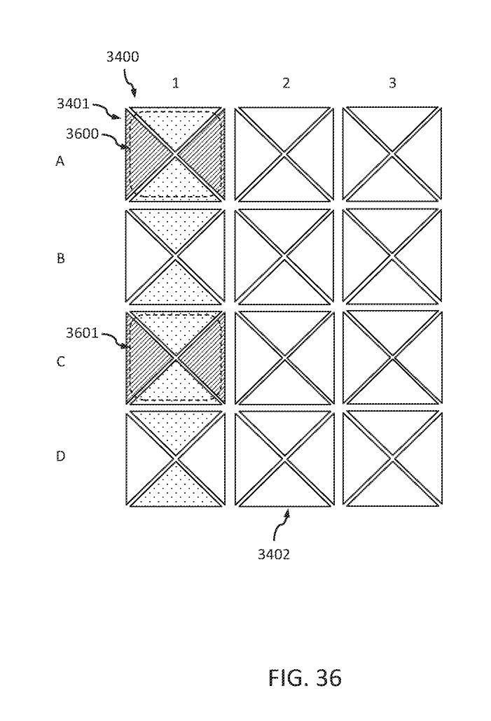

FIG. 35 shows an electrode assignment that may be used with the electrode structure of FIG. 29 or FIG .31 during a second measurement period. This pattern includes sense electrodes 3500, drive electrodes 3501, and unused electrodes 3502. In the embodiments of FIGS. 35 and 36, therefore, each electrode region (e.g., A1, B1, etc.) may have more than one type of sense, driving, and unused electrodes in a diamond pattern.

FIG. 36 shows the electrode assignment of FIG. 34, and also shows the approximate region 3600 in which a mutual capacitance is formed between drive electrode portion of A1 and sense electrode portion of A1 over a short coupling distance. The value of the mutual capacitance is affected by any objects present in the approximate region 3600. FIG. 36 further shows the approximate region 3601 in which a mutual capacitance is formed between drive electrode portion of C1 and sense electrode portion of C1 over a short coupling distance. The value of the mutual capacitance is affected by any objects present in the approximate region 3601.

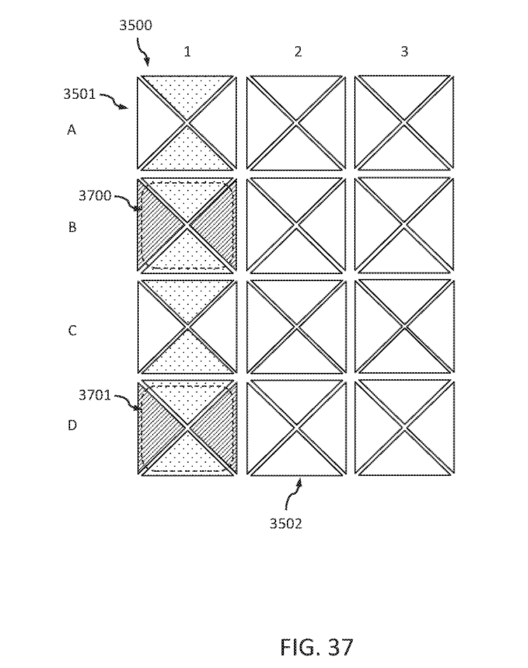

FIG. 37 shows the electrode assignment of FIG. 35, and also shows the approximate region 3700 in which a mutual capacitance is formed between drive electrode portion of B1 and sense electrode portion of B1 over a short coupling distance. The value of the mutual capacitance is affected by any objects present in the approximate region 3700. FIG. 37 further shows the approximate region 3701 in which a mutual capacitance is formed between drive electrode portion of D1 and sense electrode portion of D1 over a short coupling distance. The value of the mutual capacitance is affected by any objects present in the approximate region 3701.

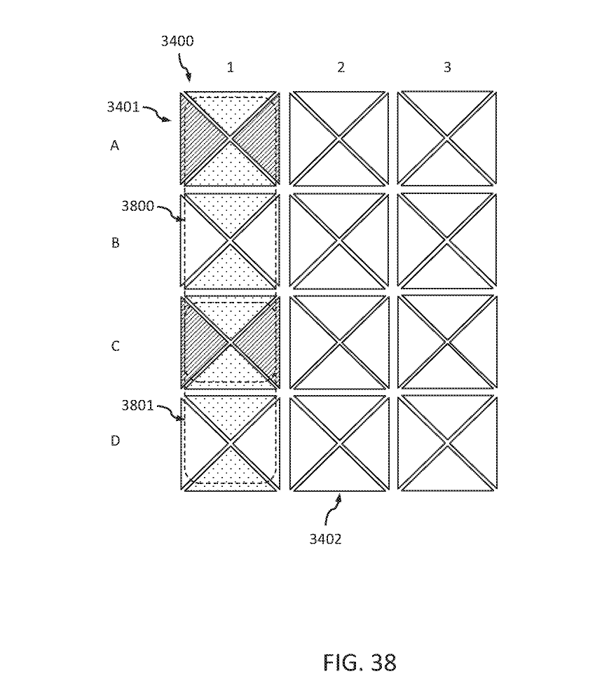

FIG. 38 shows the electrode assignment of FIG. 34, and also shows the approximate region 3800 in which a mutual capacitance is formed between drive electrodes portions of A1 and C1 and sense electrode portion of B1 over long coupling distances.

The value of the mutual capacitance is affected by any objects present in the approximate region 3800. FIG. 38 further shows the approximate region 3801 in which a mutual capacitance is formed between drive electrode portion of C1 and sense electrode portion D1 over a long coupling distance. The value of the mutual capacitance is affected by any objects present in the approximate region 3801.

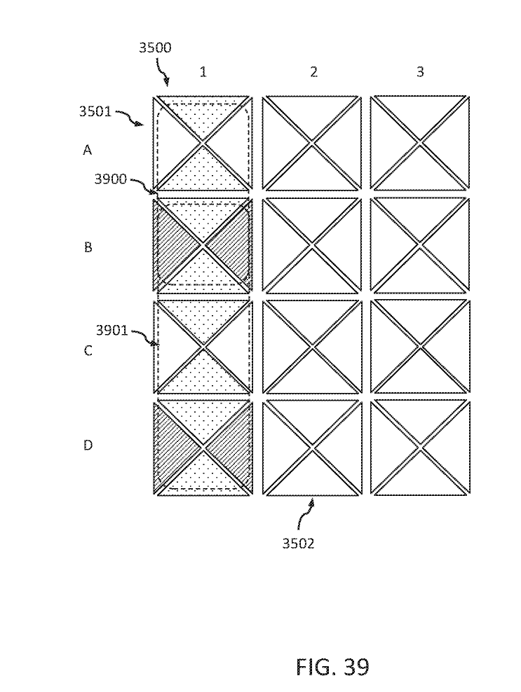

FIG. 39 shows the electrode assignment of FIG. 35, and also shows the approximate region 3900 in which a mutual capacitance is formed between drive electrode portion of B1 and sense electrode portion of A1 over a long coupling distance. The value of the mutual capacitance is affected by any objects present in the approximate region 3900. FIG. 39 further shows the approximate region 3901 in which a mutual capacitance is formed between drive electrode portions of B1 and D1 and sense electrode portion of C1 over long coupling distances. The value of the mutual capacitance is affected by any objects present in the approximate region 3901.

Additional electrode patterns may be used in subsequent measurement periods that result in additional mutual capacitances, formed over different coupling distances, with different approximate sensitive regions.

As with other embodiments, two data sets are obtained containing measurements of multiple mutual capacitances formed over different coupling distances at different points on the touch panel over the different measurement periods. The data sets are used to detect conductive and non-conductive objects that may be touching or in close proximity to any point on the surface of the touch panel.

The two data sets may also be used to determine whether an object that is touching or in close proximity to any point on the surface of the touch panel is a conductive object or a non-conductive object. Conductive objects may be detected and identified based on a first characteristic change in the multiple mutual capacitances formed over different coupling distances. Non-conductive objects may be detected and identified based on a second characteristic change in the multiple mutual capacitances formed over different coupling distances.

The two data sets may further be used to determine the height of an object that is in close proximity to any point on the surface of the touch panel based on characteristic changes in the multiple mutual capacitances formed over different coupling distances.

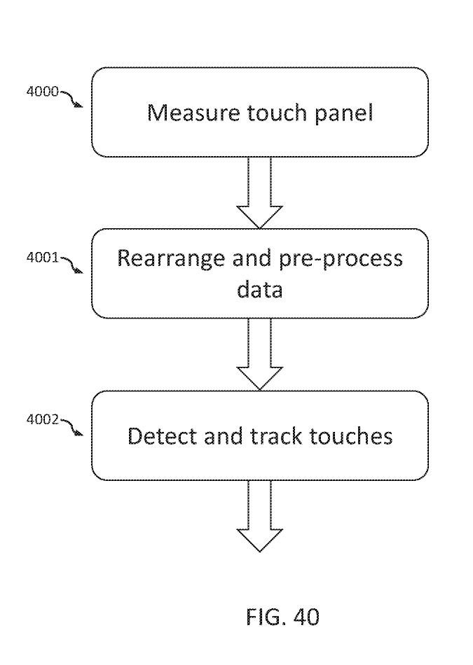

FIG. 40 shows a flow diagram depicting the steps that may be performed within the touch panel controller 403 to measure and process capacitance data from the touch sensor panel 401, and all the variations of such structures in the above embodiments. FIG. 40 shows just one embodiment of a possible algorithm, and many other embodiments are also possible.

FIG. 40 shows a first step, 4000, during which mutual capacitances within the touch sensor panel 401 are measured, a second step, 4001, during which the measured data is rearranged and pre-processed, and a third step, 4002, during which in a detecting and tracking step it is determined whether any objects are touching or in close proximity to the touch panel, and optionally what the properties and locations of those objects are.

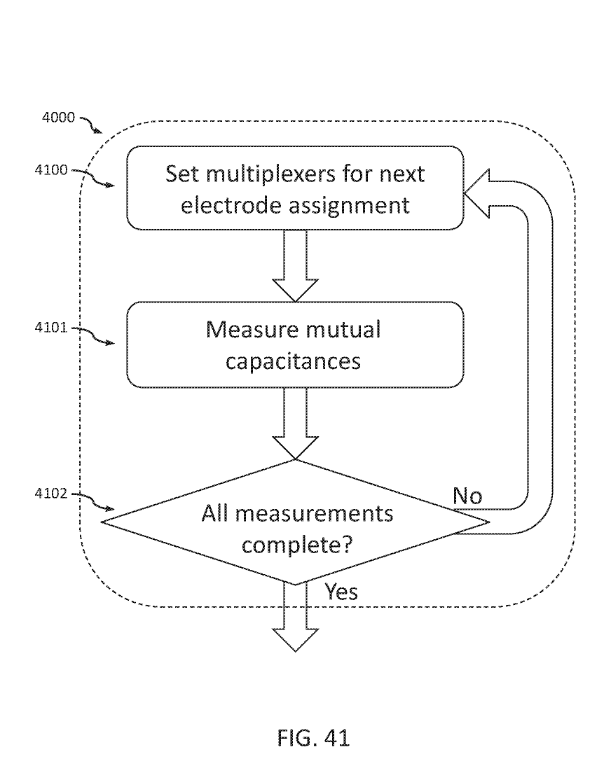

FIG. 41 shows the sub-steps that form part of the first step 4000. During the first sub-step 4100 the measurement/processing unit 405 configures the multiplexer unit 404 for a next electrode assignment to produce a particular pattern of drive, sense, and unused electrodes. During the second sub-step 4101 the measurement/processing unit 405 measures the mutual capacitances between the drive and sense electrodes. During the third sub-step 4102, the measurement/processing unit 405 determines whether all necessary measurements have been made. If more measurements are required, for example to obtain full spatial coverage of the panel, execution is returned to sub-step 4100. Otherwise, the algorithm proceeds to the second step 4001.

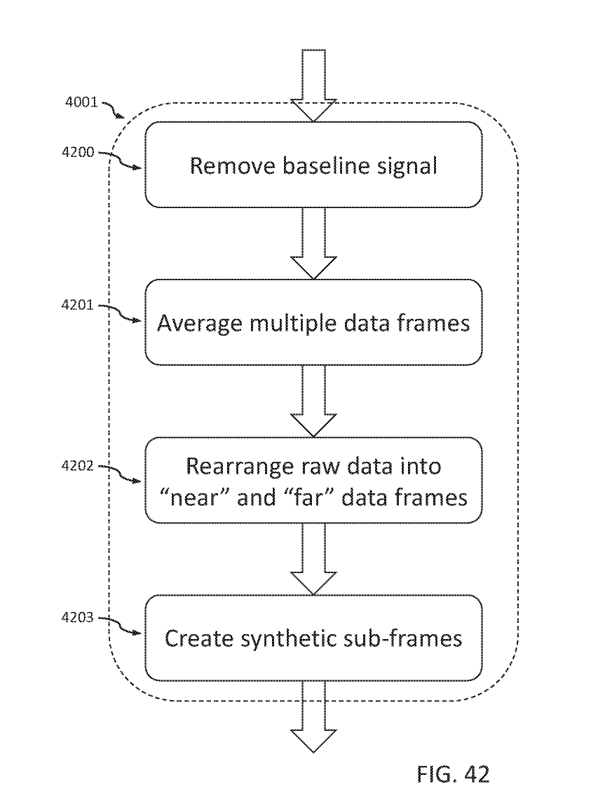

FIG. 42 shows the sub-steps that form part of the second step 4001. During the first sub-step 4200 a baseline capacitance signal may be removed from the measured capacitances. During the second sub-step 4201, data from multiple measurement data frames may be averaged to reduce noise. During a third sub-step 4202 the raw data of mutual capacitance measurements are rearranged into different “near” and “far” data frames of measurement data. For example, a first frame may be a near data frame containing measurements corresponding to mutual capacitances measured over short coupling distances at a number of locations on the touch sensor panel. A second frame may be a far data frame containing measurements corresponding to mutual capacitances measured over long coupling distances at a number of locations on the touch sensor panel. Different groups of measurements may be processed to make them directly comparable with each other. This processing may include changing the spatial resolution of the data, interpolation, scaling, and other well-known algorithmic techniques. During a fourth sub-step 4203, “synthetic sub-frames” may be created by combining the measurement data. For example, a first synthetic sub-frame may include the sum of the first frame of measurements (measurements corresponding to mutual capacitances measured over short coupling distances) and the second frame of measurements (measurements corresponding to mutual capacitances measured over long coupling distances). A second synthetic sub-frame may include the difference between the first frame of measurements (measurements corresponding to mutual capacitances measured over short coupling distances) and the second frame of measurements (measurements corresponding to mutual capacitances measured over long coupling distances).

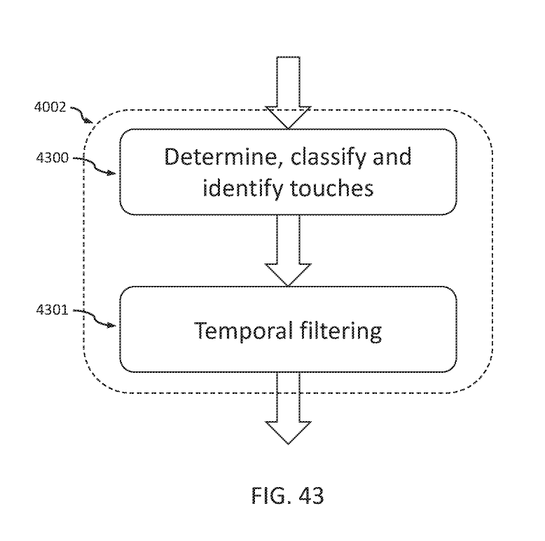

FIG. 43 shows the sub-steps that form part of the third step 4002. During the first sub-step 4300 the synthetic sub-frames are processed to determine, classify, and identify touches. Sub-step 4300 may be employed to detect objects that are touching or in close proximity to the surface of the touch panel. The synthetic sub-frames may also be processed to determine the location of the objects on the surface of the touch panel, and/or the type of object (conductive or non-conductive), and/or the height of the object above the surface of the touch panel.

For example, the first synthetic sub-frame in this embodiment can be processed to detect conductive objects. The second synthetic sub-frame in this embodiment can be processed to detect non-conductive objects. By comparing the magnitudes of measurements in the first and second synthetic sub-frames, an object can be classified as conductive or non-conductive, and its height above the surface of the touch panel may be determined. This is just one embodiment of an algorithm that can be used to rearrange the measurement data, and detect, locate and classify conductive and non-conductive objects. Any suitable algorithms may be employed.

During the second sub-step 4301 of FIG. 43, temporal filtering may be applied. Suitable filtering techniques are well-known in the prior art.

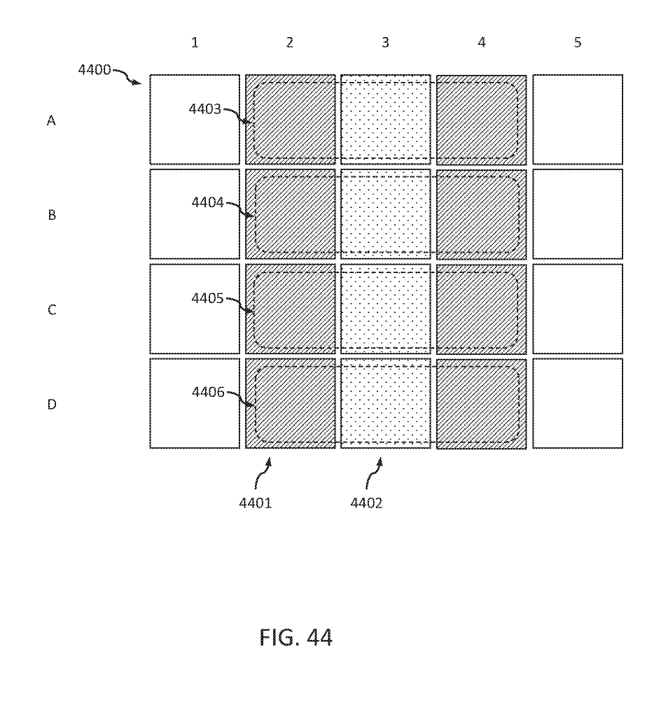

FIG. 44 shows an electrode assignment that may be used during a measurement period. This assignment includes unused electrodes 4400, drive electrodes 4401, and sense electrodes 4402 again as indicated by the differences in shading in the figure. FIG. 44 also shows the approximate region 4403 in which a mutual capacitance is formed between drive electrodes A2 and A4 and sense electrode A3 over a short coupling distance. The value of the mutual capacitance is affected by any objects present in the approximate region 4403. FIG. 44 further shows the approximate region 4404 in which a mutual capacitance is formed between drive electrodes B2 and B4 and sense electrode B3 over a short coupling distance. The value of the mutual capacitance is affected by any objects present in the approximate region 4404. FIG. 44 similarly shows two additional approximate sensitive regions 4405 and 4406 in which mutual capacitances are formed between different electrodes.

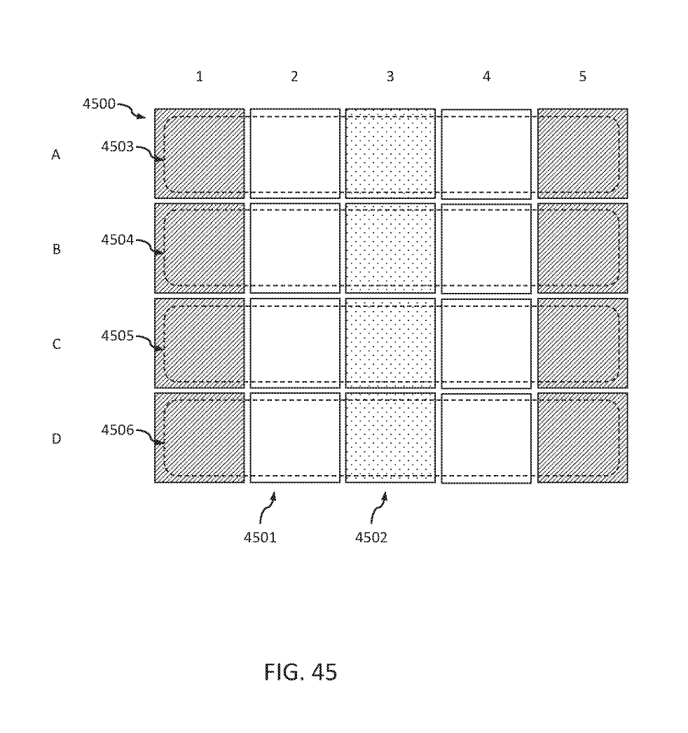

FIG. 45 shows an electrode assignment that may be used during a measurement period. This assignment includes drive electrodes 4500, unused electrodes 4501, and sense electrodes 4502 again as indicated by the differences in shading in the figure. FIG. 45 also shows the approximate region 4503 in which a mutual capacitance is formed between drive electrodes A1 and A5 and sense electrode A3 over a long coupling distance. The value of the mutual capacitance is affected by any objects present in the approximate region 4503. FIG. 45 further shows the approximate region 4504 in which a mutual capacitance is formed between drive electrodes B1 and B5 and sense electrode B3 over a long coupling distance. The value of the mutual capacitance is affected by any objects present in the approximate region 4504. FIG. 45 similarly shows two additional approximate sensitive regions 4505 and 4506 in which mutual capacitances are formed between different electrodes.

In one embodiment of the present invention, the electrode assignment of FIG. 44 may be used in a measurement period, and the electrode assignment of FIG. 45 may be used in a subsequent measurement period.

An aspect of the invention, therefore, is a touch panel device having enhanced electrode control for detecting and determining the position of an object that touches or is in closed proximity to the touch panel device. In exemplary embodiments, the touch panel device may include a two dimensional array of electrodes comprising a plurality of electrodes, and a controller electrically coupled to the two dimensional array of electrodes. A first portion of the electrodes are assignable by the controller as drive electrodes or unused electrodes, and a second portion of the electrodes are assignable by the controller as sense electrodes or unused electrodes. The controller is configured to: assign drive electrodes and sense electrodes during a plurality of measurement periods, wherein a pattern of assigned drive electrodes and sense electrodes is different during different measurement periods, and the assigned drive electrodes and sense electrodes form mutual capacitances over a plurality of coupling distances during the plurality of measurement periods; measure mutual capacitances formed between the drive electrodes and the sense electrodes during the measurement periods; and detect and determine a position of an object that is touching or in close proximity to the touch panel device based on the measured mutual capacitances. The touch panel device may include one or more of the following features, either individually or in combination.

In an exemplary embodiment of the touch panel device, any point on a surface of the touch panel device is included at least in a sensitive region of mutual capacitance formed over a first coupling distance and a sensitive region of mutual capacitances formed over a second coupling distance different from the first coupling distance.

In an exemplary embodiment of the touch panel device, the plurality of coupling distances comprises a short coupling distance and a long coupling distance

In an exemplary embodiment of the touch panel device, each electrode that is assignable as a sense electrode has a separate electrical connection to the controller.

In an exemplary embodiment of the touch panel device, every electrode in the two dimensional array has a separate electrical connection to the controller.

In an exemplary embodiment of the touch panel device, the controller is configured to assign the drive electrodes and the sense electrodes such that in more than half of the plurality of measurement periods, each sense electrode is either substantially adjacent to a drive electrode, or is diagonally adjacent to a drive electrode, and no sense electrode is both substantially and diagonally adjacent to a drive electrode.

In an exemplary embodiment of the touch panel device, the controller is configured to assign the drive electrodes and the sense electrodes such that: for any pair of drive and sense electrodes that form a mutual coupling capacitance over a long coupling distance, an electrode assigned as a sense electrode in a first configuration during a first measurement period is assigned as a drive electrode in a second configuration during a second measurement period; and for any pair of drive and sense electrodes which form a mutual coupling capacitance over a short coupling distance, an electrode assigned as a sense electrode in the first configuration during the first measurement period is assigned as an unused electrode in the second configuration during the second measurement period.

In an exemplary embodiment of the touch panel device, the measured mutual capacitances include capacitances measured at an edge of the two dimensional array.

In an exemplary embodiment of the touch panel device, all electrodes in the two dimensional array that are not located at an edge of the two dimensional array are assigned as drive electrodes either in exactly two measurement periods or in exactly zero measurement periods.

In an exemplary embodiment of the touch panel device, the plurality of electrodes are interdigitated in one direction only.

In an exemplary embodiment of the touch panel device, the controller comprises a current measurement unit for measuring the mutual capacitances and a multiplexer, and the controller is configured to control a connection via the multiplexer between the current measurement unit and the touch panel electrodes to assign the sense electrodes; wherein each electrode that is assignable as a sense electrode has a separate electrical connection to the multiplexer.

In an exemplary embodiment of the touch panel device, every electrode in the two dimensional array has a separate electrical connection to the multiplexer.

In an exemplary embodiment of the touch panel device, the touch panel device further includes a multiplexer unit, wherein during each measurement period the multiplexer unit connects each electrode that is assigned as a drive electrode to a drive voltage and each electrode that is assigned as a sense electrode to one or more sense amplifiers, and connects each electrode that is assigned as an unused electrode to ground or to a fixed voltage.

In an exemplary embodiment of the touch panel device, the controller being configured to detect the object includes being configured to determine whether the object is conductive or non-conductive based on characteristic changes in the measured mutual capacitances.

In an exemplary embodiment of the touch panel device, the controller is configured to: detect conductive objects based on a first characteristic change of the mutual capacitances formed over different coupling distances; and detect non-conductive objects additionally based on a second characteristic change of the mutual capacitances formed over different coupling distances.

In an exemplary embodiment of the touch panel device, the controller being configured to determine the position of the object includes being configured to determine a height of the object above a surface of the touch panel device based on characteristic changes in the measured mutual capacitances.

In an exemplary embodiment of the touch panel device, the controller is configured to process the measured mutual capacitances to produce frames of data corresponding to capacitive coupling over different coupling distances.

In an exemplary embodiment of the touch panel device, the controller is configured to process the frames of data to have a same spatial resolution.

Another aspect of the invention is a method of controlling a touch panel device accordingly to any of the embodiments. The method may include the steps of: assigning drive electrodes and sense electrodes during a plurality of measurement periods, wherein a pattern of assigned drive electrodes and sense electrodes is different during different measurement periods, and the assigned drive electrodes and sense electrodes form mutual capacitances over a plurality of coupling distances during the plurality of measurement periods; measuring mutual capacitances formed between the drive electrodes and the sense electrodes during the measurement periods; and detecting and determining a position of an object that is touching or in close proximity to the touch panel device based on the measured mutual capacitances; wherein the touch panel device performs a function in response to the object being touching or in close proximity to the touch panel device.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

The present invention is suitable for improving operation of capacitive type touch panel devices in a variety of contexts. Such capacitive type touch panel devices may find application in a range of consumer electronic products including, for example, mobile phones, tablet, laptop and desktop PCs, electronic book readers and digital signage products.

1. A touch panel device comprising:
a two dimensional array of electrodes comprising a plurality of electrodes; and a
controller electrically coupled to the two dimensional array of electrodes;
wherein a first portion of the electrodes are assignable by the controller as drive electrodes or unused electrodes, and a second portion of the electrodes are assignable by the controller as sense electrodes or unused electrodes; and
wherein the controller is configured to:
assign drive electrodes and sense electrodes during a plurality of measurement periods, wherein a pattern of assigned drive electrodes and sense electrodes is different during different measurement periods, and the assigned drive electrodes and sense electrodes form mutual capacitances over a plurality of coupling distances during the plurality of measurement periods;
measure mutual capacitances formed between the drive electrodes and the sense electrodes during the measurement periods; and
detect and determine a position of an object that is touching or in close proximity to the touch panel device based on the measured mutual capacitances.

2. The touch panel device of claim 1, wherein any point on a surface of the touch panel device is included at least in a sensitive region of mutual capacitance formed over a first coupling distance and a sensitive region of mutual capacitances formed over a second coupling distance different from the first coupling distance.

3. The touch panel device of claim 1, wherein the plurality of coupling distances comprises a short coupling distance and a long coupling distance

4. The touch panel device of claim 1, wherein each electrode that is assignable as a sense electrode has a separate electrical connection to the controller.

5. The touch panel device of claim 1, wherein every electrode in the two dimensional array has a separate electrical connection to the controller.

6. The touch panel device of claim 5, wherein the controller is configured to assign the drive electrodes and the sense electrodes such that in more than half of the plurality of measurement periods, each sense electrode is either substantially adjacent to a drive electrode, or is diagonally adjacent to a drive electrode, and no sense electrode is both substantially and diagonally adjacent to a drive electrode.

7. The touch panel device of claim 5, wherein the controller is configured to assign the drive electrodes and the sense electrodes such that:
for any pair of drive and sense electrodes that form a mutual coupling capacitance over a long coupling distance, an electrode assigned as a sense electrode in a first configuration during a first measurement period is assigned as a drive electrode in a second configuration during a second measurement period; and
for any pair of drive and sense electrodes which form a mutual coupling capacitance over a short coupling distance, an electrode assigned as a sense electrode in the first configuration during the first measurement period is assigned as an unused electrode in the second configuration during the second measurement period.

8. The touch panel device of claim 5, wherein the measured mutual capacitances include capacitances measured at an edge of the two dimensional array.

9. The touch panel device of claim 5, where all electrodes in the two dimensional array that are not located at an edge of the two dimensional array are assigned as drive electrodes either in exactly two measurement periods or in exactly zero measurement periods.

10. The touch panel device of claim 5, wherein the plurality of electrodes are interdigitated in one direction only.

11. The touch panel device of claim 1, wherein the controller comprises a current measurement unit for measuring the mutual capacitances and a multiplexer, and the controller is configured to control a connection via the multiplexer between the current measurement unit and the touch panel electrodes to assign the sense electrodes;
wherein each electrode that is assignable as a sense electrode has a separate electrical connection to the multiplexer.

12. The touch panel device of claim 11, wherein every electrode in the two dimensional array has a separate electrical connection to the multiplexer.

13. The touch panel device of claim 1, further comprising a multiplexer unit, wherein during each measurement period the multiplexer unit connects each electrode that is assigned as a drive electrode to a drive voltage and each electrode that is assigned as a sense electrode to one or more sense amplifiers, and connects each electrode that is assigned as an unused electrode to ground or to a fixed voltage.

14. The touch panel device of claim 1, wherein the controller being configured to detect the object includes being configured to determine whether the object is conductive or non-conductive based on characteristic changes in the measured mutual capacitances.

15. The touch panel device of claim 1, wherein the controller is configured to:
detect conductive objects based on a first characteristic change of the mutual capacitances formed over different coupling distances; and
detect non-conductive objects additionally based on a second characteristic change of the mutual capacitances formed over different coupling distances.

16. The touch panel device of claim 1, wherein the controller being configured to determine the position of the object includes being configured to determine a height of the object above a surface of the touch panel device based on characteristic changes in the measured mutual capacitances.

17. The touch panel device of claim 1, wherein the controller is configured to process the measured mutual capacitances to produce frames of data corresponding to capacitive coupling over different coupling distances.

18. The touch panel device of claim 19, wherein the controller is configured to process the frames of data to have a same spatial resolution.

19. A method of controlling a touch panel device, the touch panel device including a two dimensional array of electrodes comprising a plurality of electrodes and a controller electrically coupled to the two dimensional array of electrodes, wherein a first portion of the electrodes are assignable by the controller as drive electrodes or unused electrodes, and a second portion of the electrodes are assignable by the controller as sense electrodes or unused electrodes, the control method comprising the steps of:
assigning drive electrodes and sense electrodes during a plurality of measurement periods, wherein a pattern of assigned drive electrodes and sense electrodes is different during different measurement periods, and the assigned drive electrodes and sense electrodes form mutual capacitances over a plurality of coupling distances during the plurality of measurement periods;
measuring mutual capacitances formed between the drive electrodes and the sense electrodes during the measurement periods; and
detecting and determining a position of an object that is touching or in close proximity to the touch panel device based on the measured mutual capacitances;
wherein the touch panel device performs a function in response to the object being touching or in close proximity to the touch panel device.
